(19) United States
(12) Patent Application Publication
(10) Pub. No.: US 2021/0342754 A1
(43) Pub. Date: Nov. 4, 2021

(54) SYSTEMS AND METHODS FOR GENERATING TRAVEL ITINERARIES THROUGH A SOCIAL INTERACTION PLATFORM

(71) Applicant: GlobalX Travel Technologies, Inc., Miami, FL (US)

(72) Inventor: Aaron Paul Baalbergen, San Juan, PR (US)

(73) Assignee: GlobalX Travel Technologies, Inc., Miami, FL (US)

(21) Appl. No.: 17/301,653

(22) Filed: Apr. 9, 2021

Related U.S. Application Data
(60) Provisional application No. 63/008,455, filed on Apr. 10, 2020.

(51) Int. Cl. G06Q 10/02; G06Q 50/00

(52) U.S. Cl. CPC G06Q 10/025; G06Q 50/01

(57) ABSTRACT

Systems, methods, and storage media for generating travel itineraries through a social interaction platform are disclosed. Exemplary implementations may: register at least one interaction between a first user and a second user; generate at least one travel itinerary from a plurality of itinerary elements stored within the data store as a result of the at least one interaction; and present the at least one travel itinerary to at least one user.

### CROSS-REFERENCE TO RELATED APPLICATIONS

The present application claims priority under 35 U.S.C. § 119(e) of U.S. Provisional Patent Application Ser. No. 63/008,455 filed on Apr. 10, 2020 and titled SOCIAL NETWORK TO INTRODUCE TRAVELERS AND ALIGN SCHEDULES FOR CHARTER FLIGHTS AND OFFERS, the contents of which are incorporated herein by reference in their entirety.

### COPYRIGHT NOTICE

A portion of this disclosure contains material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### FIELD OF THE DISCLOSURE

The present disclosure relates to systems and methods for generating travel itineraries through a social interaction platform.

### BACKGROUND

Throughout the patentable landscape there are multiple instances of platforms allowing user to engage in researching, coordinating, and securing travel arrangements. However, they are based on the legacy ‘top-down’ model where the travel provider selects the destinations and the tools at a user's disposable are merely ways to find a provider with an offering that satisfies the user's needs. Platforms like Uber and Airbnb, i.e. the gig economy, have turned several industries into bottom-up models. That has not happened yet with long-haul, high-capacity travel, such as flights, as that would require coordinating many users to agree on destinations and itineraries.

Social network platforms, like Instagram, have developed algorithms to track user interaction such as ‘likes’ and determine trends and use predictions to push to users what they are likely to be interested in, such as photos. However, these two concepts have not been combined in one platform. Therefore, at the nexus of travel arrangement platforms and social media networks there are no unified systems or methods that can resolve these issues in an efficient, user-driven way.

This background information is provided to reveal information believed by the applicant to be of possible relevance to the present invention. No admission is necessarily intended, nor should be construed, that any of the preceding information constitutes prior art against the present invention.

### SUMMARY

One aspect of the present disclosure relates to a system configured for generating travel itineraries through a social interaction platform. The system may include one or more hardware processors configured by machine-readable instructions. The processor(s) may be configured to register, through a network, at least one interaction between a first user and a second user. The processor(s) may be configured to generate, through the at least one processor, at least one travel itinerary from a plurality of itinerary elements stored within a data store as a result of the at least one interaction. The processor(s) may be configured to present, through a remote platform 104, the at least one travel itinerary to at least one user.

In some implementations of the system, the processor(s) may be configured to associate, through the at least one processor, an itinerary element within the data store with at least one user prior to registering the at least one interaction between the first and second user.

In some implementations of the system, the at least one interaction may include the first and second user associating with the same itinerary element within the data store.

In some implementations of the system, the at least one interaction may include synchronous communication between the first and second user.

In some implementations of the system, the at least one interaction may include asynchronous communication between the first and second user.

In some implementations of the system, the at least one interaction may include a digital media file.

In some implementations of the system, the at least one interaction may include connecting the first and second user through the network.

In some implementations of the system, the processor(s) may be configured to generate, through the at least one processor, a graphical representation of the interaction between the first and second user.

In some implementations of the system, the processor(s) may be configured to display, thru the remote platform, the graphical representation of the interaction to at least one user.

In some implementations of the system, the graphical representation may be generated as a heat map representing the interaction between the first and second user.

Another aspect of the present disclosure relates to a method for generating travel itineraries through a social interaction platform. The method may include registering, through the network, at least one interaction between a first user and a second user. The method may include generating, through the at least one processor, at least one travel itinerary from a plurality of itinerary elements stored within the data store as a result of the at least one interaction. The method may include presenting, through the remote platform 104, the at least one travel itinerary to at least one user.

Yet another aspect of the present disclosure relates to a non-transient computer-readable storage medium having instructions embodied thereon, the instructions being executable by one or more processors to perform a method for generating travel itineraries through a social interaction platform. The method may include registering, through the network, at least one interaction between a first user and a second user. The method may include generating, through the at least one processor, at least one travel itinerary from a plurality of itinerary elements stored within the data store as a result of the at least one interaction. The method may include presenting, through the remote platform 104, the at least one travel itinerary to at least one user.

These, and other features and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1a illustrates a system 100 configured for generating travel itineraries through a social interaction platform, in accordance with one or more implementations.

FIG. 1b illustrates the machine-readable instructions 106 within the system 100 configured for generating travel itineraries through a social interaction platform, in accordance with one or more implementations.

FIGS. 2A, 2B, 2C, 2D, 2E, 2F, 2G, 2H, 2I, 2J, 2K, 2L, 2M, 2N, 20, 2P, 2Q, 2R, 2S, 2T, 2U, 2V, 2W, 2X, 2Y, 2Z, 2BY, and/or 2BZ illustrate a method 200 for generating travel itineraries through a social interaction platform, in accordance with one or more implementations.

FIG. 3 is a screenshot of a “New Itinerary” section within system 100 and method 200, in accordance with one or more implementations.

FIG. 4 is a screenshot of a “Add Photos” section within system 100 and method 200, in accordance with one or more implementations.

FIG. 5 is a screenshot of a “New Sight” section within system 100 and method 200, in accordance with one or more implementations.

FIG. 6 is a screenshot of a travel itinerary “Description” section within system 100 and method 200, in accordance with one or more implementations.

FIG. 7 is a screenshot of showing multiple travel itineraries within system 100 and method 200, in accordance with one or more implementations.

FIG. 8 is a screenshot of a “User Profile” section within system 100 and method 200, in accordance with one or more implementations.

FIG. 9 is a screenshot of a user “Services Offer” section within system 100 and method 200, in accordance with one or more implementations.

FIG. 10 is a screenshot of a new travel itinerary “Propose a new destination” section within system 100 and method 200, in accordance with one or more implementations.

FIG. 11 is a screenshot of a user “My destinations” section within system 100 and method 200, in accordance with one or more implementations.

FIG. 12 is a screenshot of a user “Review my likes” section within system 100 and method 200, in accordance with one or more implementations.

FIG. 13 is a screenshot of a user “My Trips” section within system 100 and method 200, in accordance with one or more implementations.

FIG. 14 is a screenshot of a “Chat” section within system 100 and method 200, in accordance with one or more implementations.

FIG. 15 is a screenshot of “Charter Flight” section within system 100 and method 200, in accordance with one or more implementations.

FIG. 16 is a screenshot of “Financial” section within system 100 and method 200, in accordance with one or more implementations.

FIG. 17 is a screenshot of travel itinerary “Search” section within system 100 and method 200, in accordance with one or more implementations.

FIG. 18 is a screenshot of a user “Invite Users Search” section within system 100 and method 200, in accordance with one or more implementations.

FIG. 19 is a screenshot of a user “Direct Messages/Chat Rooms” section within system 100 and method 200, in accordance with one or more implementations.

FIG. 20 is a screenshot of a user “Create a Chat Room” section within system 100 and method 200, in accordance with one or more implementations.

FIG. 21 is a screenshot of a second travel itinerary “Description” section within system 100 and method 200, in accordance with one or more implementations.

### DETAILED DESCRIPTION

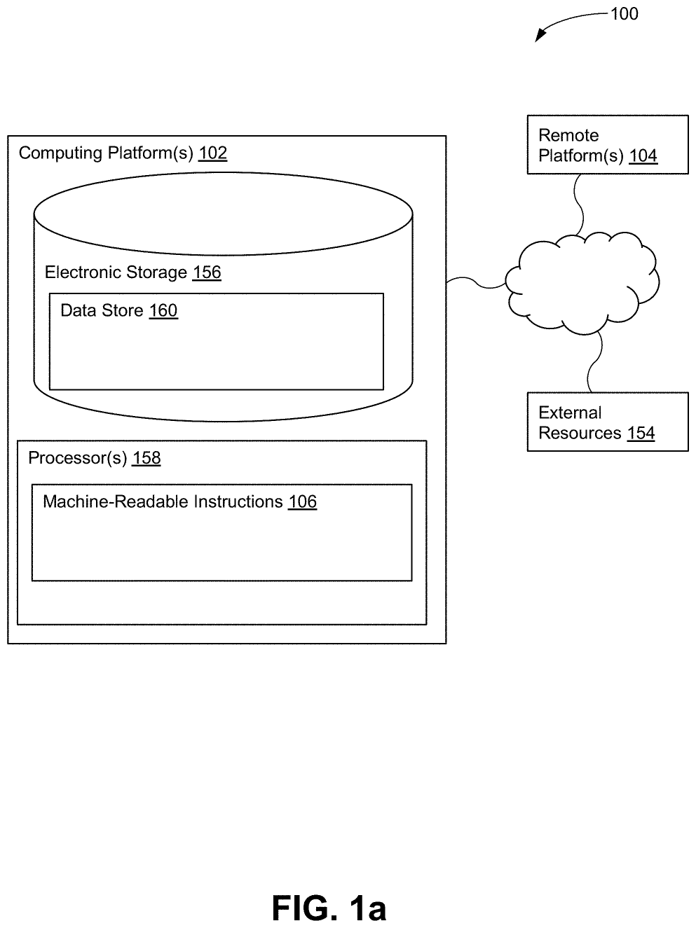

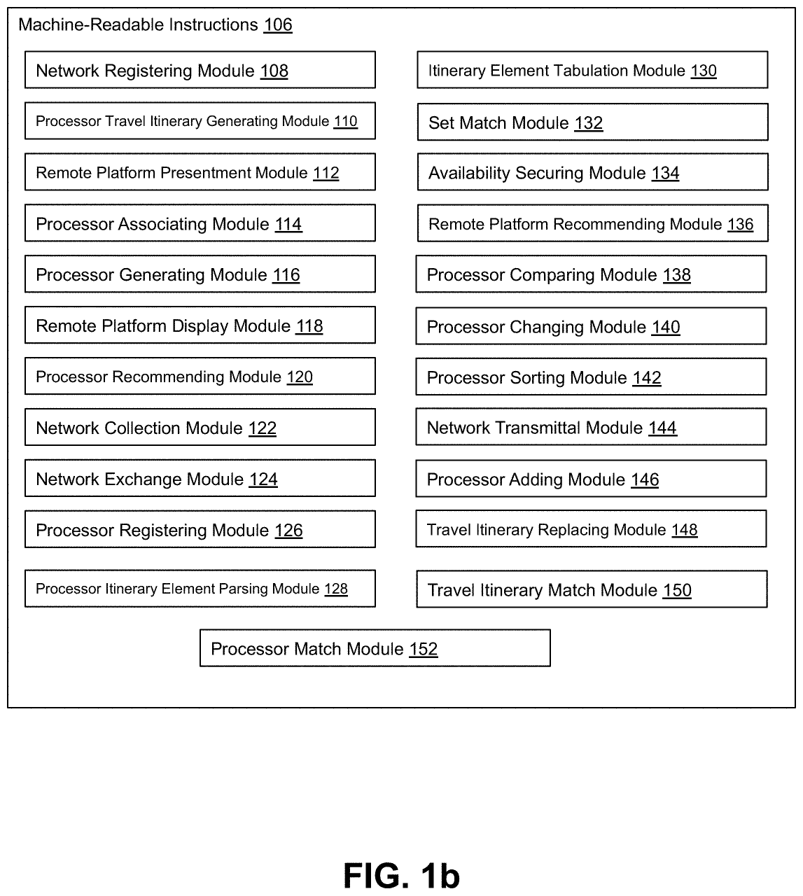

FIG. 1 illustrates a system 100 configured for generating travel itineraries through a social interaction platform, in accordance with one or more implementations. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms 104 via computing platform(s) 102 and/or according to a client/server architecture, a peer-to-peer architecture, and/or other architectures. Users may access system 100 via remote platform(s) 104 or computing platforms 102.

In some implementations system 100 is a social network that tracks user interaction and likes to predict what itineraries are trending in a given area to push those options to the feeds of users who are most likely to be interested and automatically align schedules. Analogous to how social media platforms like Instagram interact with photos, the system 100 attempts to accomplish in connection with travel itineraries. The invention then combines this with a ride-sharing style, bottom-up travel model. The result is that potential travel service providers no longer guess as to what itineraries will sell in order to then sell them to potential travelers (ie users within the system 100). Rather, the platform uses the data collecting from the social network combined with an API for carriers to create possible instances of crowd-sourced on-demand long-haul travel.

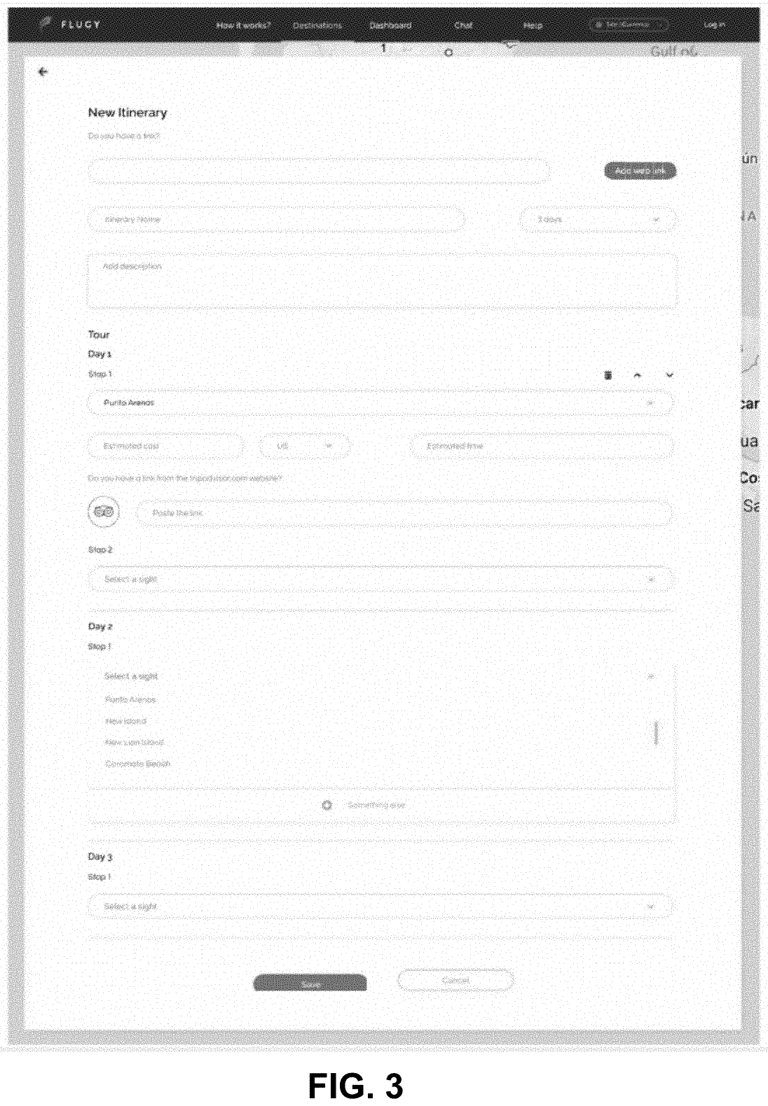

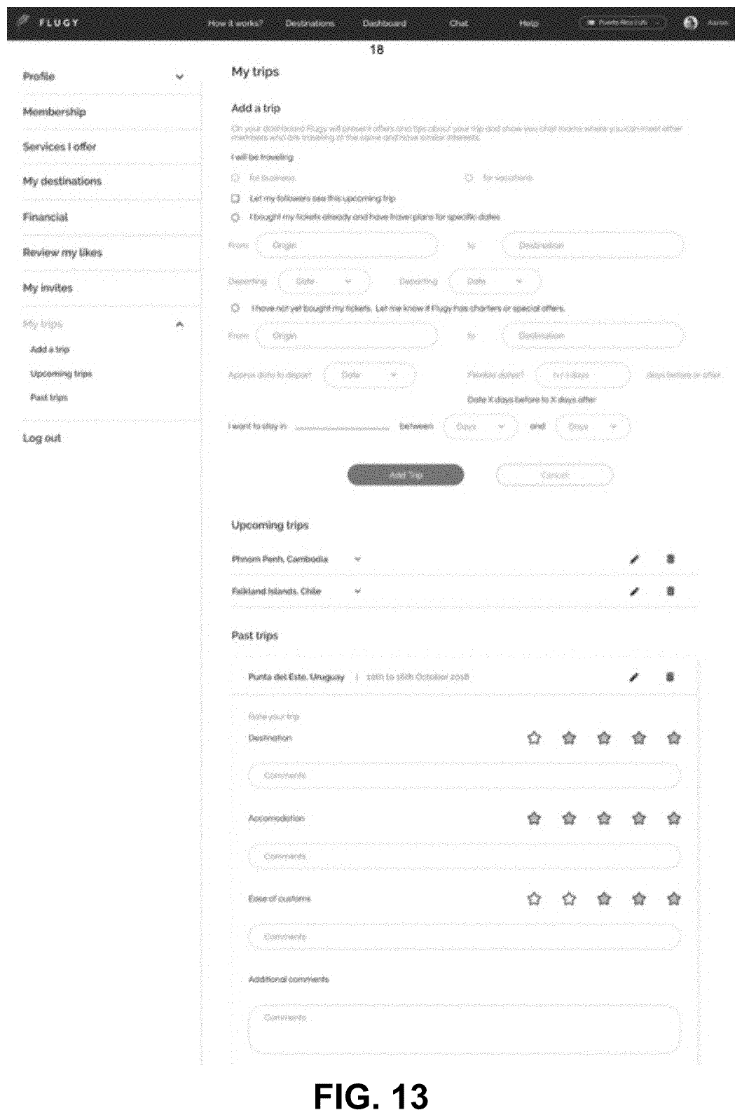

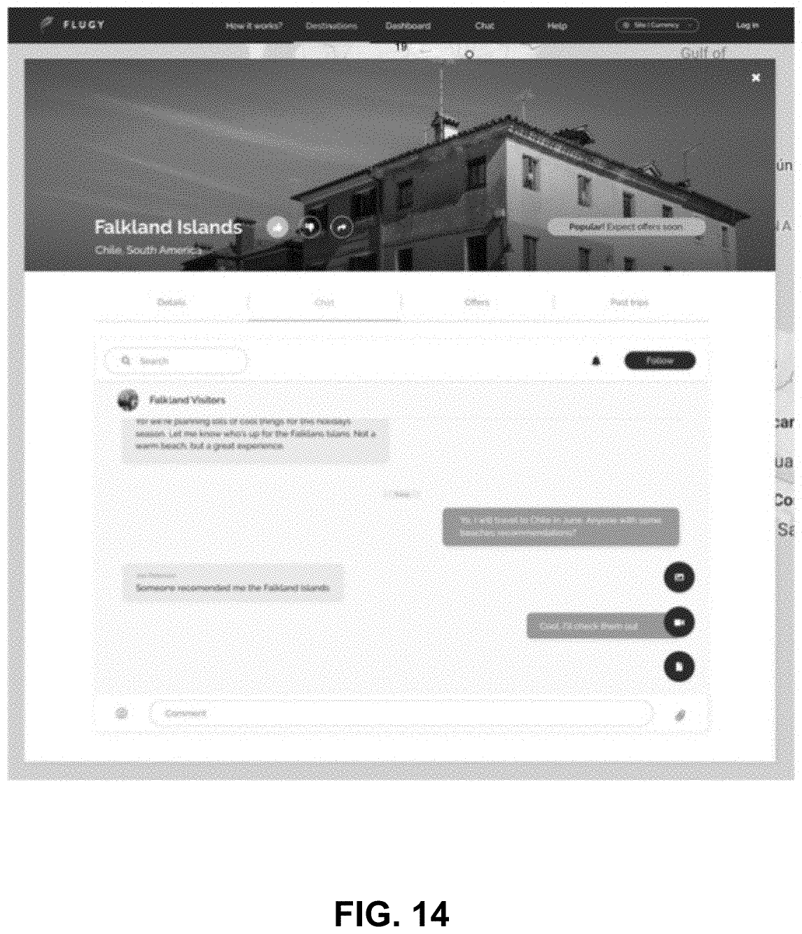

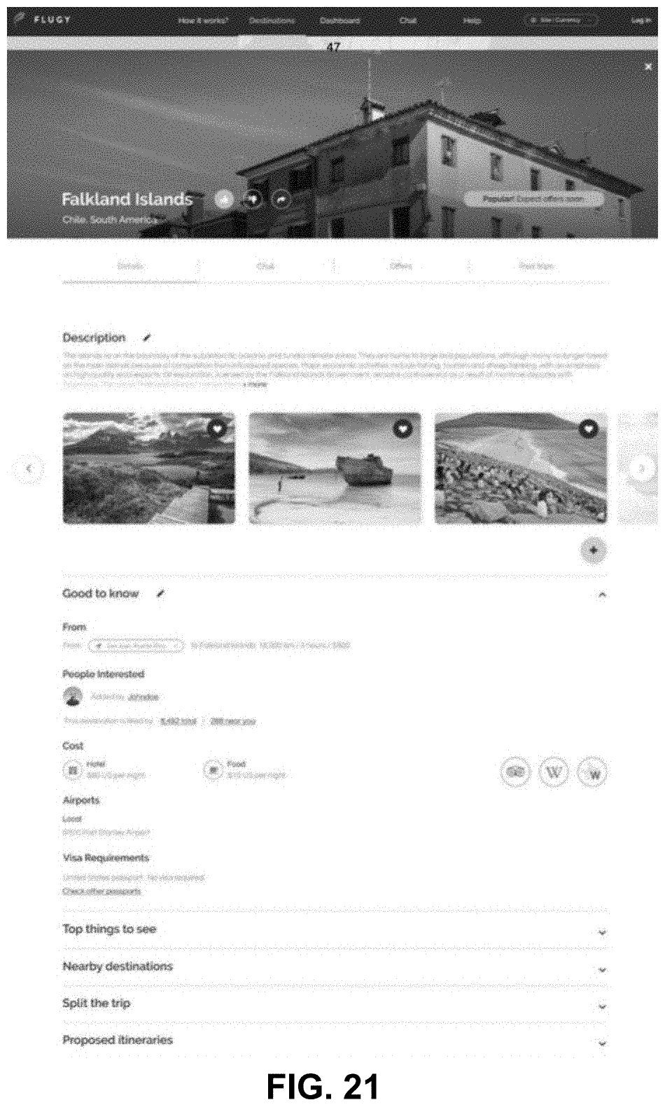

FIGS. 3 through 23 illustrate a plurality of screenshots associated with the system 100, in accordance with one or more implementations. It should be noted that the screenshots are meant to demonstrate the functionality of the elements and operations described throughout this specification. Any elements within these figures that may fall under copyright protection are not meant to be limiting in any way.

Computing platform(s) 102 may be configured by machine-readable instructions 106. Machine-readable instructions 106 may include one or more instruction modules. The instruction modules may include computer program modules. The instruction modules may include one or more of network registering module 108, processor travel itinerary generating module 110, remote platform presentment module 112, processor associating module 114, processor generating module 116, remote platform display module 118, processor recommending module 120, network collection module 122, network exchange module 124, processor registering module 126, processor itinerary element parsing module 128, itinerary element tabulation module 130, set match module 132, availability securing module 134, remote platform recommending module 136, processor comparing module 138, processor changing module 140, processor sorting module 142, network transmittal module 144, processor adding module 146, travel itinerary replacing module 148, travel itinerary match module 150, processor match module 152, and/or other instruction modules.

A Network registering module 108 may be configured to register, through a network, at least one interaction between a first user and a second user. The Network registering module 108 may also be configured to register, through the network, at least one interaction between a user and the system. A user is defined as a single person that has created an account within the system 100 and utilizes the system 100 in order to interact with the various mechanics of the system and generate potential travel itineraries. Additionally, multiple persons may also constitute a “user” in order to engage in collective interactions with single user and generate travel itineraries within the system 100. The second user may also be a travel service provider. Here a travel service provider may include a travel agency, charter flight airline, commercial service airline, group travel organizer, event coordinator, or any type of person or entity that would create itinerary elements (discussed below) or travel itineraries to present to other users within or using the system 100.

An “interaction” is the fundamental mechanism of engagement within the system 100 and encompasses many ways that the system 100 registers when users are interested in similar itinerary elements in order to generate travel itineraries based on those elements. These interactions can be registered internally within system 100 or registered thru additional systems in connection with system 100 thru the external resources 154. Such examples of these system include other social media networks such as Facebook, Twitter, and/or Instagram as well as communication platforms such as WhatsApp, Slack, LINE, and/or KaKaoTalk. These interactions can take many forms within the system 100 and will be discussed in depth below.

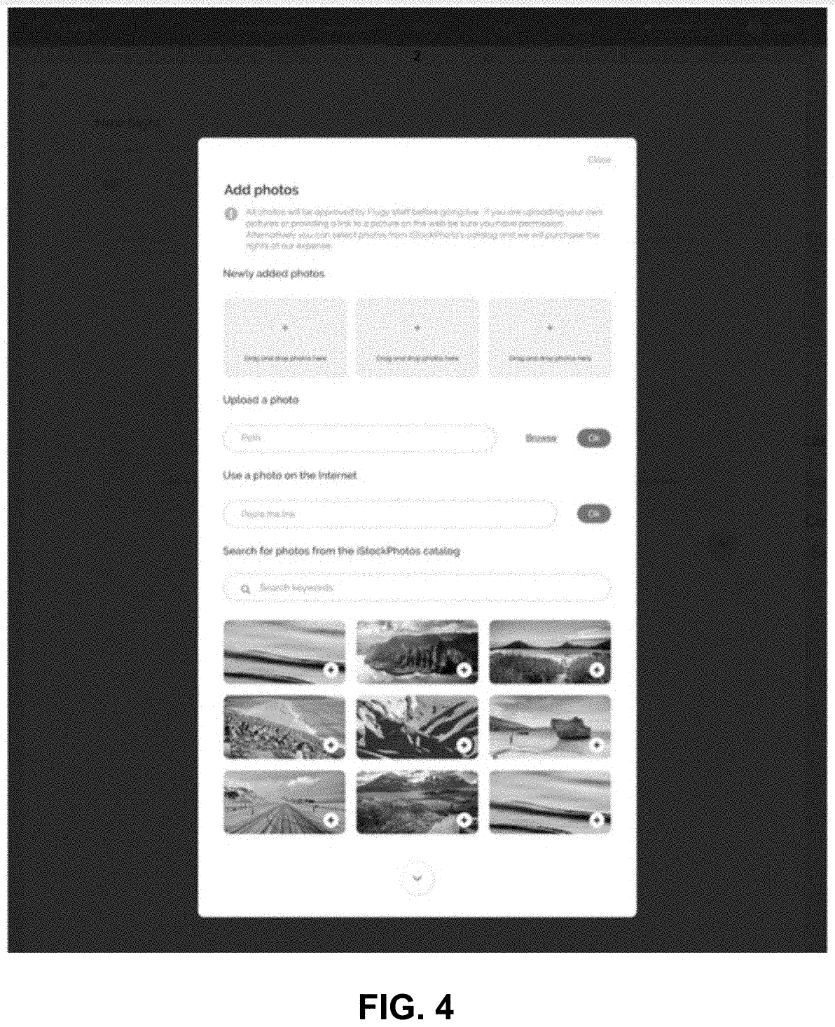

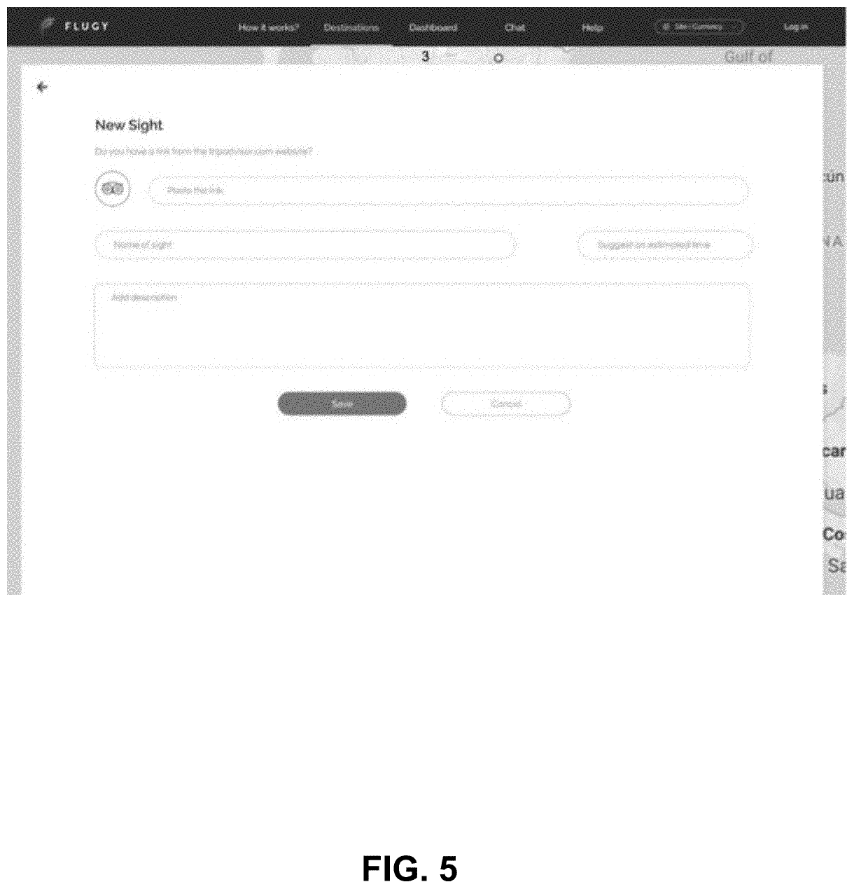

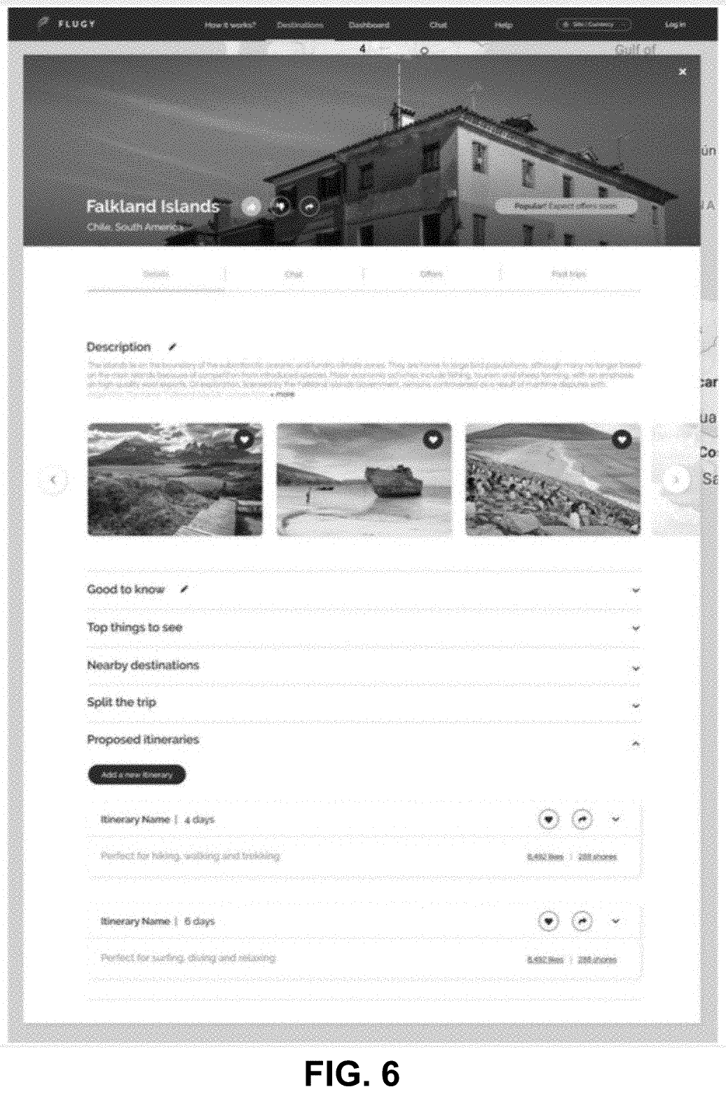

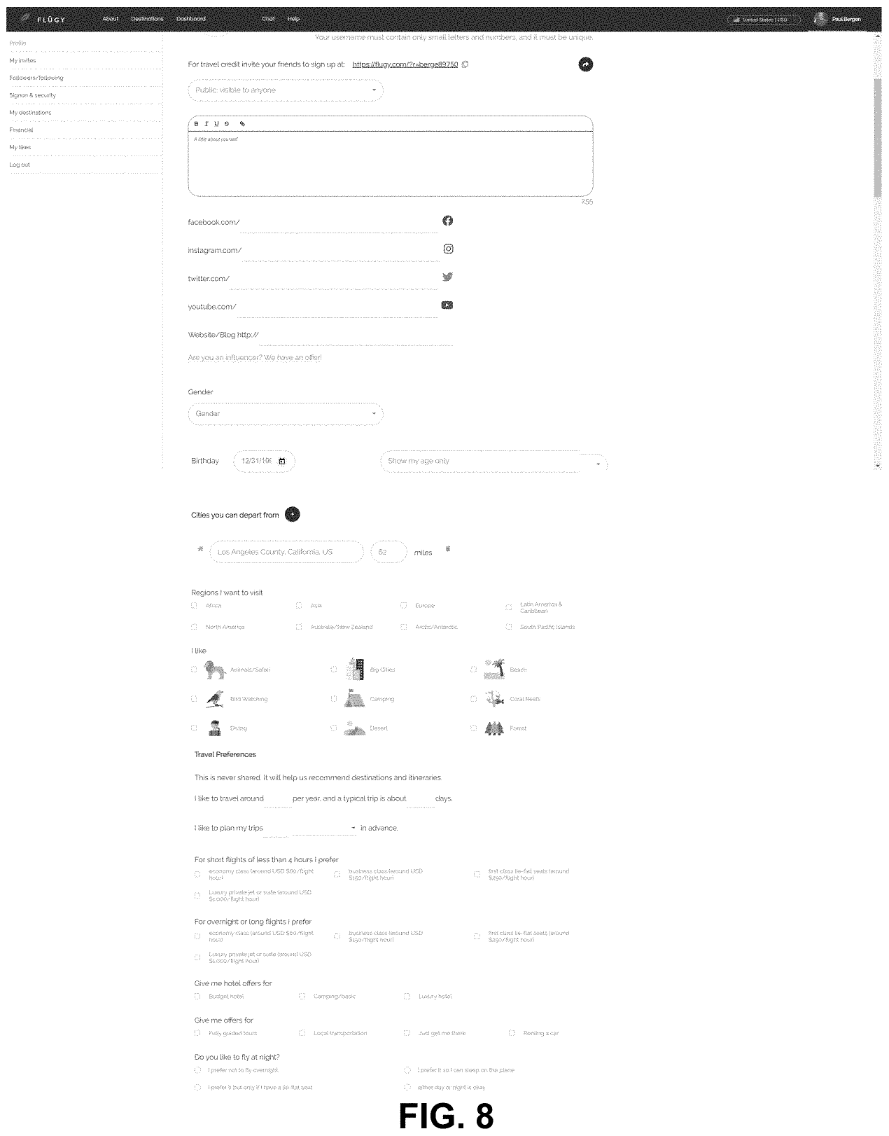

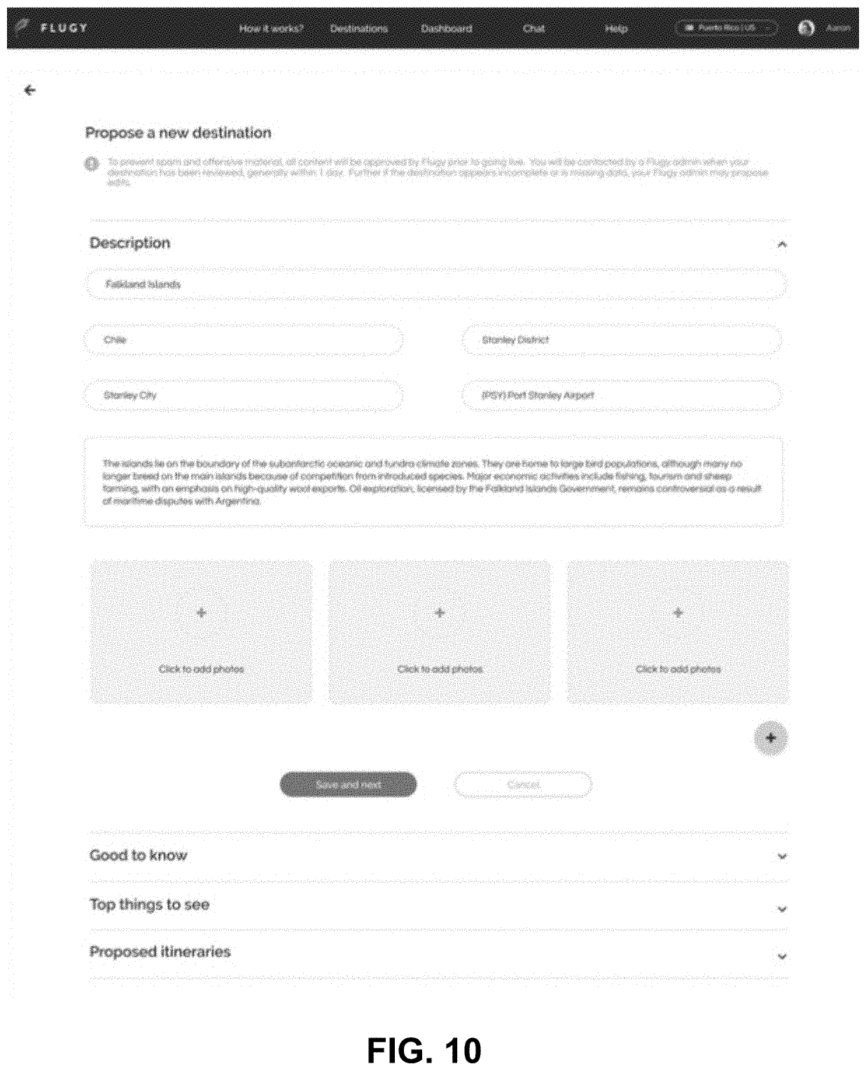

In some implementations, the at least one interaction may include the first and second user associating with the same itinerary element within the data store 160. The most basic interaction registered by the system 100 is when users associate themselves to the same itinerary element. Examples of this can involve users liking the same location (bottom of FIG. 6), providing the same destination within their profile (Shown in FIG. 3, FIG. 5, and FIG. 8), or adding similar photos (shown in FIG. 4, FIG. 10).

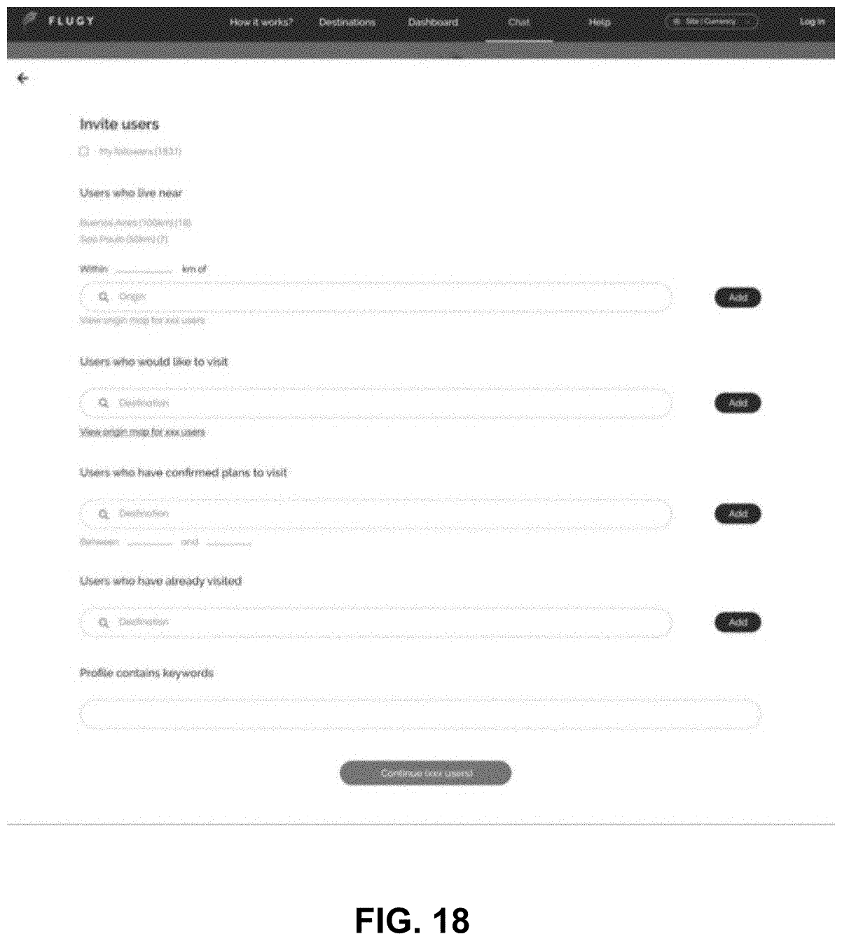

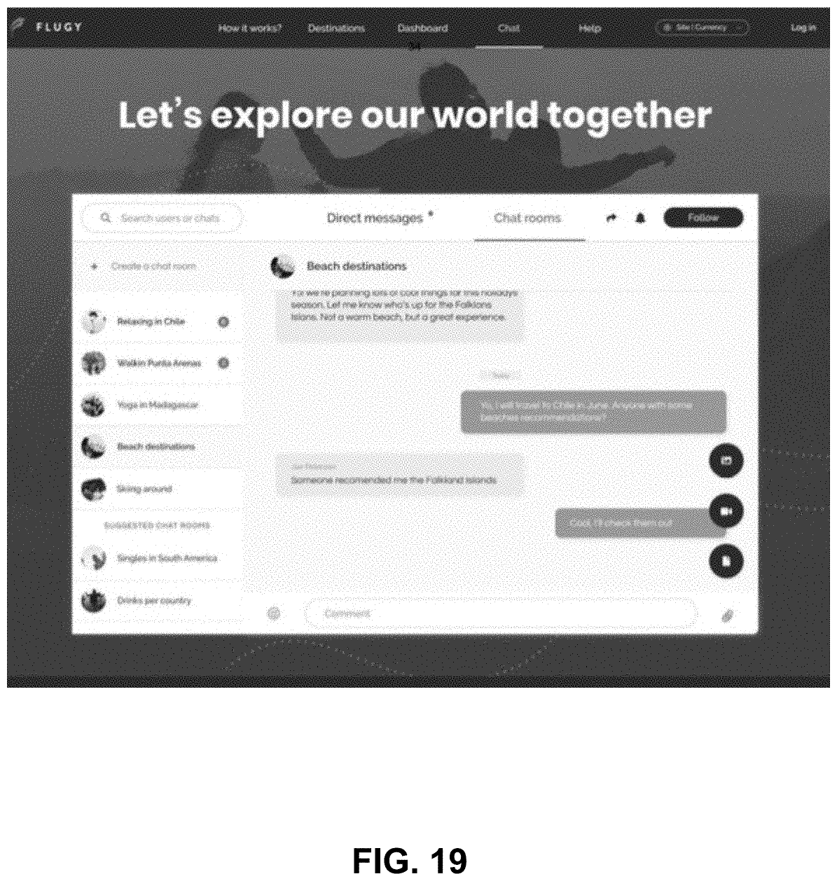

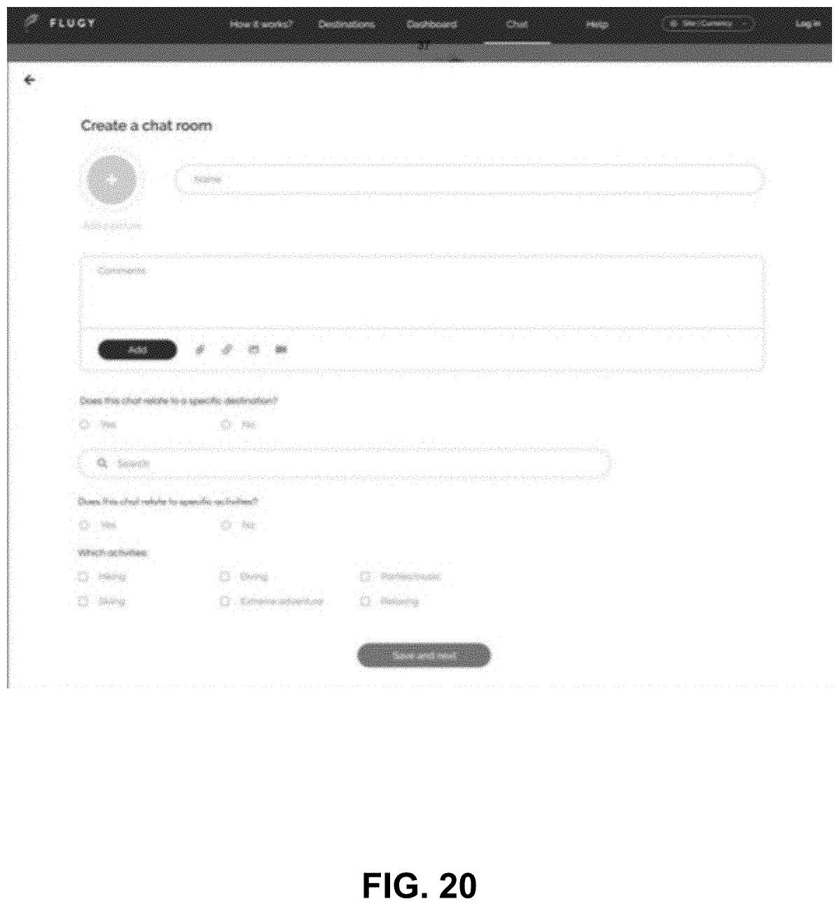

In some implementations, the at least one interaction may include connecting the first and second user through the network. In some implementations, the at least one interaction may include synchronous communication between the first and second user. In some implementations, the at least one interaction may include asynchronous communication between the first and second user. As shown in FIGS. 19 and 20, the system 100 allows for users to interact with one another by way of both synchronous communication (such as chat rooms) and asynchronous communication (such as direct messages). FIG. 20 demonstrates the creation of a chat room including images and additional meta-data that can be registered by the system 100 as additional interactions that can be used to generate potential travel itineraries. FIG. 18 also demonstrates another form of asynchronous communication thru the “invite user” section built into the system 100.

Such forms of communication can be recommended by the system 100 between based on common itinerary elements or generated travel itineraries between the users. Furthermore, these communication-based interactions are not limited to conversation-based communication and can include references such as hashtags, hyper-links, and other coded language-based communications. Finally, communication-based interactions are also not limited to registered interaction within the system 100 and may also include registered interactions imported into the system 100 from external resources in network communication with the system 100.

In some implementations, the at least one interaction may include a digital media file. A digital media file may include any graphical/audio/video element as discussed previously. As shown in FIG. 4 and FIG. 10, the addition of photos, audio clips, and videos allows users to engage with one another and allows the system 100 to register interactions as a result of those media files.

Processor travel itinerary generating module 110 may be configured to generate, through the at least one processor, at least one travel itinerary from a plurality of itinerary elements stored within the data store 160 as a result of the at least one interaction. A travel itinerary is analogous to any travel itinerary commonly generated for travel outside of the system 100 except that it is generated as a result of the interactions between users and/or the system 100 and is composed from the plurality of itinerary elements found within the data store 160. The data store may reside within the electronic storage 156 but may also reside within the external resources 154 that communicate with the system 100 as well.

The plurality of itinerary elements within the data 160 constitute all the many data points that can be utilized to generate a travel itinerary within the system 100. These elements are used both as elements for interactions between the user(s) and the system 100 as well as for components that the system 100 can use in order to build possible additional travel itineraries. These itinerary elements may be used individually or in combination with other itinerary elements in order to trigger additional unique interactions between the users and generate further travel itineraries within the system 100.

In some implementations, the plurality of itinerary elements may include a travel location. This can include any geographic destination such as country, city, generalized region, resort area and/or point of interest. FIGS. 6, 7, 14, and 21 show the Falkland Islands as an example of a “travel location” itinerary element.

In some implementations, the plurality of itinerary elements may include a mode of transportation. This includes any possible mode of private travel (charter jets), commercial travel (Airline, Rail, bus), or packaged travel (i.e. Cruises) whether international, domestic, regional, or local.

In some implementations, the plurality of itinerary elements may include a travel date.

In some implementations, the plurality of itinerary elements may include a travel destination type. In can include types of locations (as above) as well as types of hotels, resorts, and any other type of accommodations.

In some implementations, the plurality of itinerary elements may include an activity type. This can include activities provided by the travel service providers as users or by users as recommendations. Some travel locations may also include an activity type as an associated itinerary element.

In some implementations, the plurality of itinerary elements may include an event. Any number of calendared events may also be present within system including musical, cultural, sport, and regional interest events. These events may be searchable by the user(s) in order to generate travel itineraries surrounding those events.

In some implementations, the plurality of itinerary elements may include a seating theme. When the users are asked what type of ‘theme’ or seating zone(s) they would to sit in, such as: ‘card players’, ‘families with children’, ‘singles’, ‘adventure lovers’, ‘photography buffs’, the system 100 generates a travel itinerary where the seating map during their travel is divided into those themes or zones based on the expected number of passengers, and the passenger map shows the zones so passengers can sit in their desired zone and meet people with similar interests.

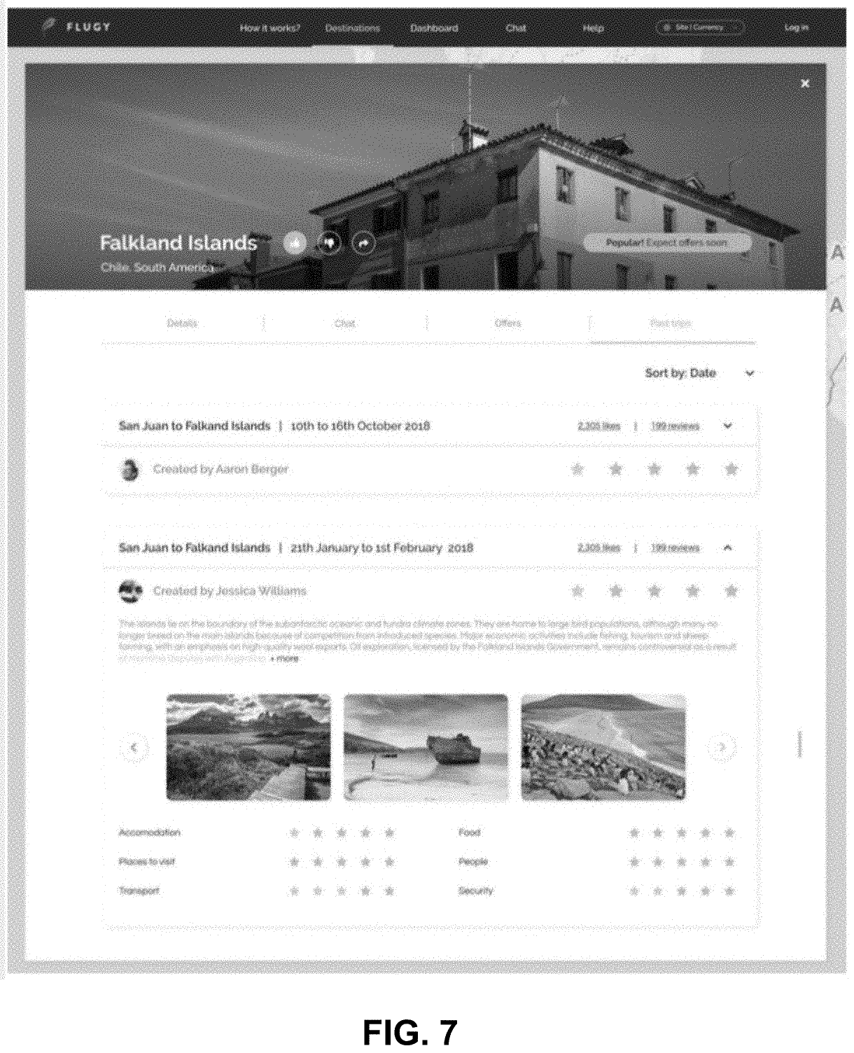

Remote platform presentment module 112 may be configured to present, through the remote platform 104, the at least one travel itinerary to at least one user. As a result of the interaction, the system 100 will present to a user (or a plurality of users) the generated travel itinerary as a result of interactions within the system 100. FIGS. 7, 11, 12, 13, and 15 are all representative screenshots of points where the system 100 will present travel itineraries (either as destination, liked trips, charter flights, other events or possible travel) that are generated from the interactions within the system 100.

Remote platform presentment module 112 may also be configured to present, thru the remote platform 104, at least one itinerary element from the data store 160 to at least one user along with the opportunity for a second interaction as a result of the first interaction. Given the types of the interactions between the user(s) and the system 100, the system 100 will attempt to generate possible travel itineraries from those initial interactions and also present additional interactions in order to further narrow down travel itineraries with higher levels of interest for a plurality of users. Presenting may further include displaying a visual representation of the itinerary element to the user. This visual representation may include text (a popup saying “if you liked Y, you may also like . . . ”) as well as media files and graphics that represent similar itinerary elements.

Remote platform presentment module 112 may also be configured to present, thru the remote platform 104, at least one itinerary element to the user prior to registering the interaction between the user and the system 100. FIG. 4 presents an example of this “pre-interaction” mechanism thru the initial photos presented to the user for selection. The system 100 will use these photos in order to generate possible travel itineraries or itinerary elements of interest to the user and begin the process.

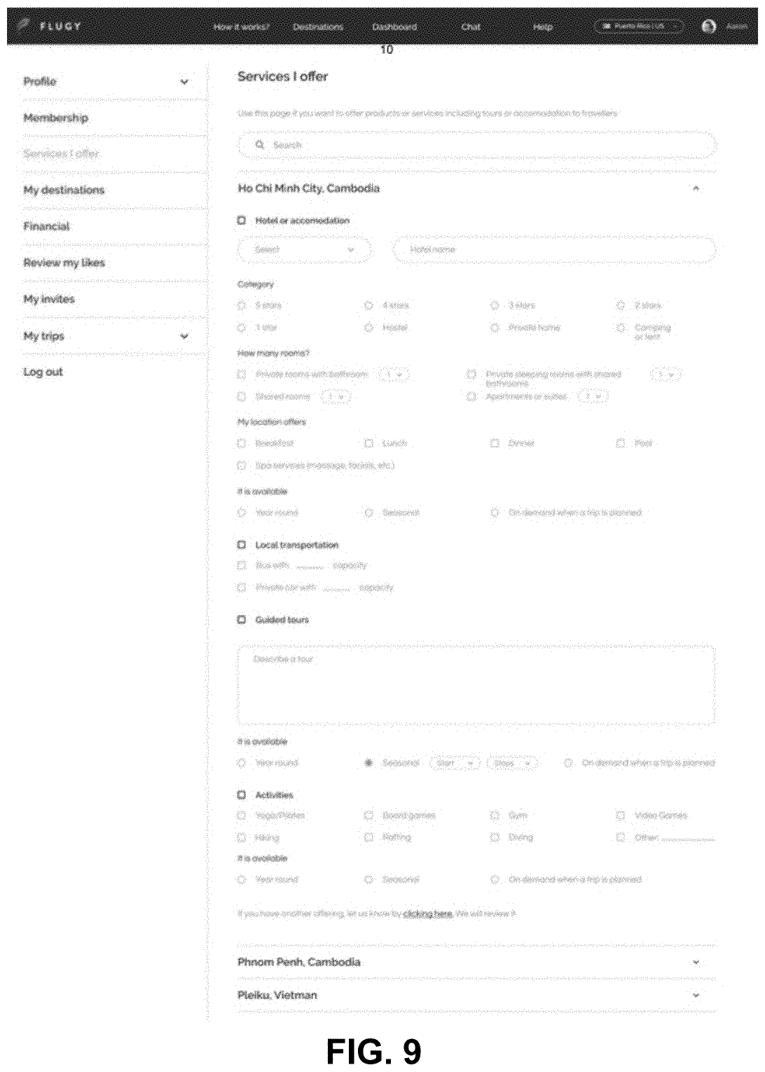

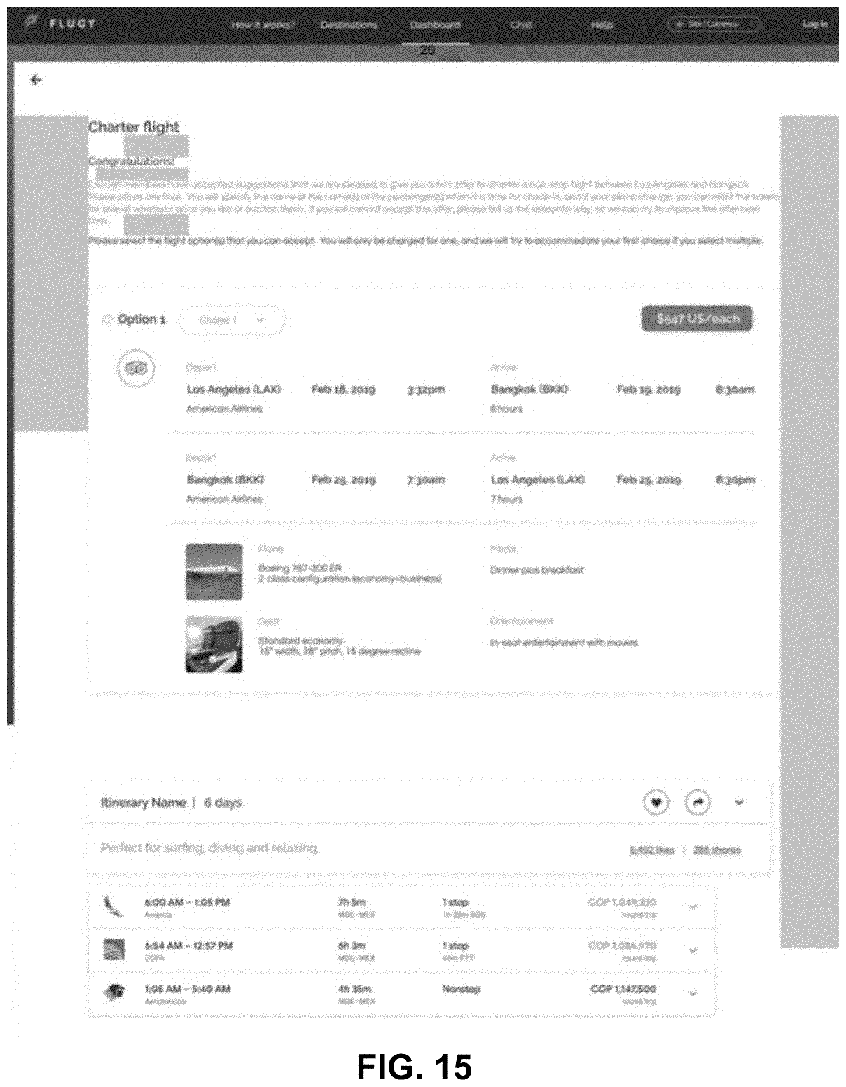

Processor associating module 114 may be configured to associate, through the at least one processor, an itinerary element within the data store 160 with at least one user prior to registering the at least one interaction between the first and second user. Processor associating module 114 may also be configured to associate, through the at least one processor, an itinerary element within the data store 160 with at least one user prior to registering the at least one interaction between the user and the system 100. As discussed above regarding FIG. 4, the system 100 may utilized captures information from the user(s) initial profile in order to initiate interactions and determine possible travel itineraries for generation. This can be determined from the user's inputted identity data (such as age, gender, current location) or by requested travel history information. FIG. 9 includes a user(s) ability to integrate past and future travel plans into their profile. FIG. 15 demonstrates the ability for a user to ‘like’ a travel destination as an interaction with the system 100.

Processor associating module 114 may also be configured to associate, thru the at least one processor, a travel schedule to at least one user after securing availability. In this context, a travel schedule may include any logistical travel tied to transportation (such as those included in the mode of transport itinerary element above) and the most analogous to current travel arrangements found within the known art. When seats are secured for any given travel schedule that is associated with a travel itinerary, the system 100 will notify users that have expressed interest thru their interactions with the system 100 and allow them to reserve all necessary elements tied to that travel itinerary. FIG. 15 demonstrates this mechanism first by showing a user a secured charter flight along with additional options tied to the previously generated travel itinerary.

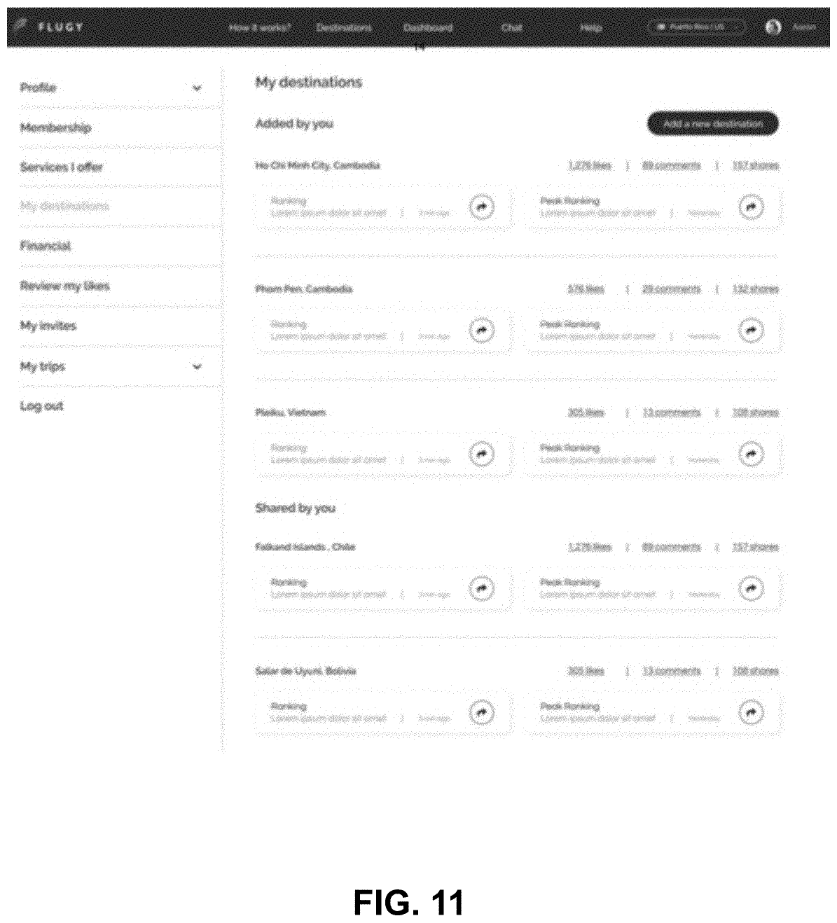

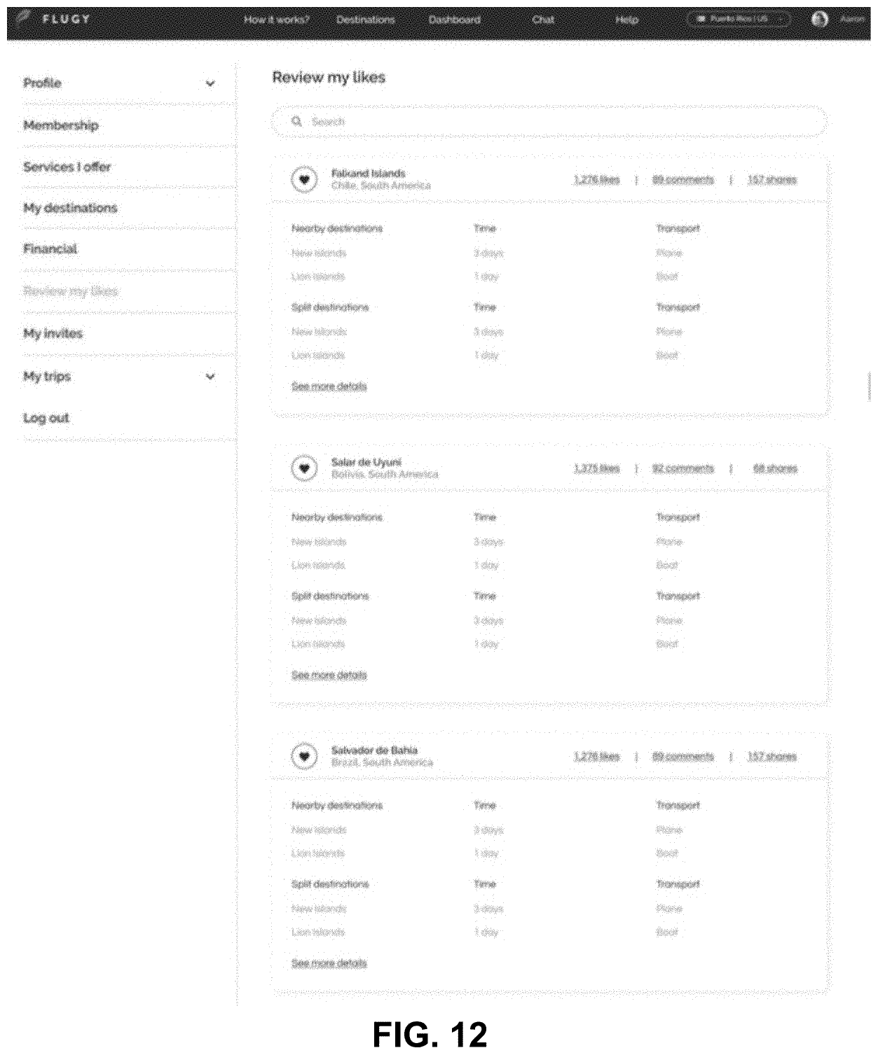

Processor associating module 114 may also be configured to associate, thru the at least one processor, an additional itinerary element to at least one user associated with the generated travel itinerary. The generated travel itinerary may be generated by a user. As seen with various screenshots, the system 100 will associate additional itinerary elements to a user once that user is associated with a travel itinerary. The “My destinations” screenshot (FIG. 11) and the “Review my likes” screenshot (FIG. 12) include travel itineraries that are selected by the user. Any of the travel itineraries within these sections will be fully associated with the user, including all travel elements found within those travel itineraries. This allows the system 100 to generate additional possible travel itineraries of interest to the user.

Processor generating module 116 may be configured to generate, through the at least one processor, a graphical representation of the interaction between the first and second user. This graphical representation may include any graphical/audio/video image that gives users an indication of an interaction between them within the system 100. ‘Like’ symbols, graphics, sounds, images of locations associated with the interactions between the user are all present throughout the various interactions mechanism within the system 100. The graphical representation may also be generated as a heat map representing the interaction between the first and second user. The heat map may be any graphical representation of concentrations of users within the system 100. This concentration may be based on any itinerary elements found within the system as well as elements that are tied to the user(s) profile (such as their present location/age/gender/etc.).

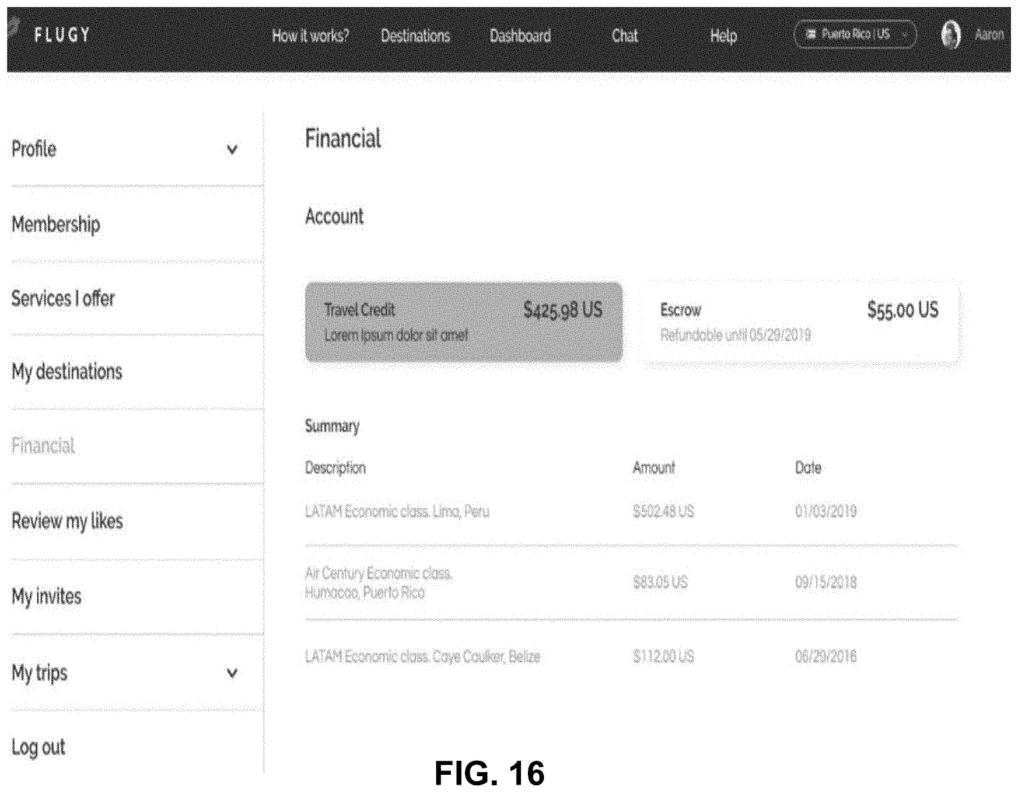

Processor generating module 116 may also be configured to generate, through the at least one processor, a credit for at least one user as a result of the interaction. Here, a credit can include funds forwarded to a user for free travel, activities, or benefits tied to a travel itinerary. FIG. 16 shows an example of a “Financial” section with multiple financial credits associated with their account. The “Travel Credit” may be in response to multiple interactions between a user in generating a travel itinerary (such as multiple “likes”, “recommendations”, chat metadata, etc.) whereas the “Escrow” account may be tied to refunded credits for travel itineraries that ultimately did not match up with corresponding travel schedules. As shown these credits may be used for other travel itineraries within the system 100. The credit may also consist of a currency credit associated with the user. The credit may be associated with at least one itinerary element within the data store 160. The credit may be associated with at least one travel schedule within the data store 160. For example, the system 100 allows users to recommend destinations and specific flights (thru generated travel itineraries). The system 100 tracks for each flight how many passengers were referred by each user, and the user who has referred the most fellow passengers receives benefits such as free seats and flight credits.

Processor generating module 116 may also be configured to generate, thru the at least one processor, an opportunity for a second interaction between the first and second user as a result of the first interaction. Processor generating module 116 may also be configured to generate, thru the at least one processor, an opportunity for a second interaction between the user and the system 100 as a result of the first interaction. Processor generating module 116 may also be configured to generate, thru the at least one processor, travel itineraries as a result of those collected interactions. The system 100 will continued to work to recommend various itinerary elements thru various interaction mechanisms in order to generate additional travel itineraries.

The interaction may include a metric associated with at least one itinerary element. These metrics are utilized by the system 100 in order to rate different itinerary elements and/or travel schedules within the data store 160 and determine their popularity amongst user(s) within the system 100.

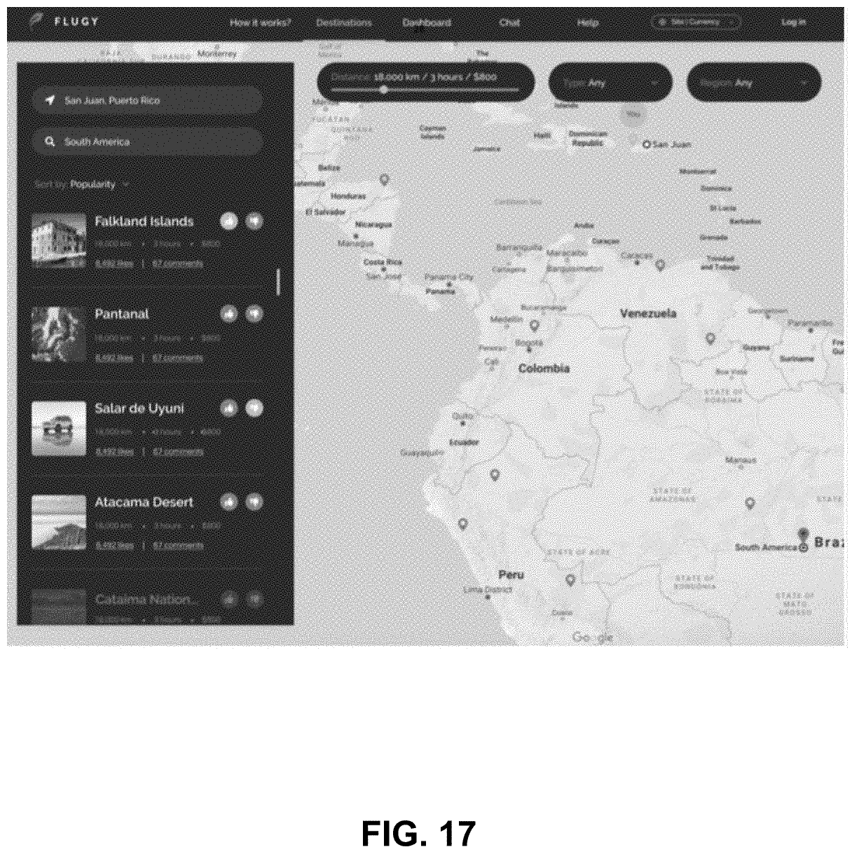

The interaction may further include the user searching for at least one itinerary element within the data store 160. FIGS. 17 and 10 demonstrate the search functionality found within the system 100 that allows a user to search within the data store 160 tied to the system 100 in order to find interesting itinerary elements or generated travel itineraries and interact in order to join or participate with those components. The interaction may further include the user(s) creating a travel itinerary from the plurality of itinerary elements within the data store 160. The “Proposed a new destination” screenshot found within FIG. 10 allows a user to create a travel itinerary from scratch and engage with the system 100 (and users).

In some implementations of the system 100, the opportunity for second interaction may include presenting at least one itinerary element from the data store 160 as a result of the interaction. The system 100 will respond to user(s) with additional recommendations to continue learning the user(s) desired locations and interests. This way the system 100 can continue to allow user(s) to engage and build more unique fitting travel between the user(s).

Remote platform display module 118 may be configured to display, thru the remote platform 104, the graphical representation of the interaction to at least one user. This will ensure that the user can see the interactions and continue to engage with the system 100. Additionally, remote platform display module 118 may be configured to display, thru the remote platform 104, the recommended itinerary element to the second user.

Processor recommending module 120 may be configured to recommend, thru the at least one processor, at least one itinerary element by the first user to the second user as a result of the registered interaction. Multiple instances within Figures of the utilizing “likes” for a given itinerary element will give the system 100 the opportunity to recommend additional itinerary and possible generated travel itineraries as the system 100 registered patterns in a given user(s) preferences. One example can be seen in FIG. 17, where liking or disliking (thru the thumbs up/thumbs down icons) will allow the system 100 to sort those destinations accordingly in later searches by a user.

Network collection module 122 may be configured to collect, thru the network, interactions across unassociated users.

Network exchange module 124 may be configured to exchange, thru the network, information with a second system 100, and generate, thru the at least one processor, a travel itinerary as a result of the exchange of information. The second system 100 may include at least one second data store 160 and the information exchanged is associated with at least one itinerary element in the first system 100 data store 160.

Processor registering module 126 may be configured to register, through the at least one processor, a plurality of generated travel itineraries from a plurality of social interactions within the system 100. Each travel itinerary may include at least one itinerary element. These collected travel itineraries can be analyzed by the system 100 in order to find commonalities among them and determine if one or more travel itineraries can be merged in order to create travel itineraries that would reach the thresholds necessary to secure availability with corresponding travel schedules. The system 100 may also generate the corresponding travel schedules in accordance with the reached thresholds. The aim of system 100 is to reduce the amount of duplicated travel itineraries and allow merged itineraries to “bubble-up” in order to reach threshold capacity with corresponding travel schedules available to the system 100.

Processor registering module 126 may be configured to register, through the at least one processor, a plurality of generated travel itineraries within the data store 160. Each travel itinerary may include at least one itinerary element.

Processor itinerary element parsing module 128 may be configured to parse, through the at least one processor, at least one itinerary element within each travel itinerary.

Itinerary element tabulation module 130 may be configured to tabulate all matching itinerary elements across the plurality of travel itineraries.

Set match module 132 may be configured to match each set of matching itinerary elements to at least one corresponding travel schedule from a plurality of travel schedules stored within the data store 160.

Availability securing module 134 may be configured to secure availability on the at least one travel schedule as a result of the matching.

Remote platform recommending module 136 may be configured to recommend, thru the remote platform 104, at least one travel itinerary to at least one user as a result of the secured availability of the at least one travel schedule.

Remote platform recommending module 136 may be configured to recommend, thru the remote platform 104, at least one itinerary element to at least one user as a result of secured availability of the at least one travel schedule.

Processor comparing module 138 may be configured to compare, thru the at least one processor, the secured availability with a minimum threshold associated with the travel schedule prior to securing availability for the tabulated travel itineraries. The minimum threshold can be set by the users that generated the travel itinerary as the required number of travelers to make a given travel itinerary viable.

Processor changing module 140 may be configured to change, thru the at least one processor, the association of the travel schedule from one user to another user.

Processor sorting module 142 may be configured to sort, through the at least one processor, the plurality of generated travel itineraries on the basis of at least one itinerary element.

Network transmittal module 144 may be configured to transmit, through the network, the sorted plurality of generated travel itineraries from the data store 160. These travel itineraries are now arranged by a particular itinerary in order to allow the system 100 to apply additional metrics and send thru the system 100 for interactions with users or further analysis to determine availability of travel schedules or requests for additional information from external resources 154 connected to the system 100.

Network transmittal module 144 may be configured to transmit, thru the network the at least one sorted travel itinerary to the at least one second data store 160. A second data store 160 may be tied to other social media networks such as Facebook, Twitter, and/or Instagram, communication platforms such as WhatsApp, Slack, LINE, and/or KaKaoTalk, as well as other third-party databases and other platforms or systems for storage and/or analysis.

Processor adding module 146 may be configured to add, thru the at least one processor, at least one additional itinerary element to at least one of the sorted travel itineraries. Additionally, travel itinerary replacing module 148 may be configured to replace the original travel itinerary within the data store 160 with the modified travel itinerary. These two modules ensure that as sorted travel itineraries are ranked by the system 100 as it determines that a) some users are differing by only one itinerary element in their generated travel itineraries and b) a unified travel itinerary with additional itinerary elements would reach a wider set of users. Thus, the system 100, thru modules 146 and 148, can incorporate additional itinerary elements (such as “Add a suggested date,” “include this activity to your destination”) into a sorted travel itinerary and replace the original one in order to recommend the modified travel itinerary to additional users within the system 100.

Travel itinerary match module 150 and Processor match module 152 may be configured to match at least one sorted travel itinerary with at least one corresponding travel schedule. Analogous to the itinerary elements discussed previously, each corresponding travel schedule may include a travel location, mode of transportation, travel date, travel destination type, seat assignment, activity type and/or event. The matching of each set of matching itinerary elements to at least one corresponding travel schedule may be based on the popularity of the travel schedule in relation to one or more other travel schedule(s) within the plurality of travel schedules. Each subsequent matching of an itinerary element with a travel schedule may increase the popularity of the travel schedule within the data store 160.

In some implementations, computing platform(s) 102, remote platform(s) 104, and/or external resources 154 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 154 may be operatively linked via some other communication method.

A given remote platform 104 may include one or more processors configured to execute computer program modules. The computer program modules may be configured to enable an expert or user associated with the given remote platform 104 to interface with system 100 and/or external resources 154, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 154 may include sources of information outside of system 100, external entities participating with system 100, and/or other resources. In some implementations, some or all of the functionality attributed herein to external resources 154 may be provided by resources included in system 100.

Computing platform(s) 102 may include electronic storage 156, one or more processors 158, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 156 may comprise non-transitory storage media that electronically stores information. The electronic storage media of electronic storage 156 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 156 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 156 may include one or more virtual storage resources (e.g., cloud storage, a virtual private network, and/or other virtual storage resources). Electronic storage 156 may store software algorithms, information determined by processor(s) 158, information received from computing platform(s) 102, information received from remote platform(s) 104, information contained within the data store 160 and/or other information that enables computing platform(s) 102 to function as described herein.

Processor(s) 158 may be configured to provide information processing capabilities in computing platform(s) 102. As such, processor(s) 158 may include one or more of a digital processor, an analog processor, a digital circuit designed to process information, an analog circuit designed to process information, a state machine, and/or other mechanisms for electronically processing information. Although processor(s) 158 is shown in FIG. 1 as a single entity, this is for illustrative purposes only. In some implementations, processor(s) 158 may include a plurality of processing units. These processing units may be physically located within the same device, or processor(s) 158 may represent processing functionality of a plurality of devices operating in coordination. Processor(s) 158 may be configured to execute modules 108, 110, 112, 114, 116, 118, 120, 122, 124, 126, 128, 130, 132, 134, 136, 138, 140, 142, 144, 146, 148, 150, and/or 152, and/or other modules. Processor(s) 158 may be configured to execute modules 108, 110, 112, 114, 116, 118, 120, 122, 124, 126, 128, 130, 132, 134, 136, 138, 140, 142, 144, 146, 148, 150, and/or 152, and/or other modules by software; hardware; firmware; some combination of software, hardware, and/or firmware; and/or other mechanisms for configuring processing capabilities on processor(s) 158. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, 126, 128, 130, 132, 134, 136, 138, 140, 142, 144, 146, 148, 150, and/or 152 are illustrated in FIG. 1 as being implemented within a single processing unit, in implementations in which processor(s) 158 includes multiple processing units, one or more of modules 108, 110, 112, 114, 116, 118, 120, 122, 124, 126, 128, 130, 132, 134, 136, 138, 140, 142, 144, 146, 148, 150, and/or 152 may be implemented remotely from the other modules. The description of the functionality provided by the different modules 108, 110, 112, 114, 116, 118, 120, 122, 124, 126, 128, 130, 132, 134, 136, 138, 140, 142, 144, 146, 148, 150, and/or 152 described below is for illustrative purposes, and is not intended to be limiting, as any of modules 108, 110, 112, 114, 116, 118, 120, 122, 124, 126, 128, 130, 132, 134, 136, 138, 140, 142, 144, 146, 148, 150, and/or 152 may provide more or less functionality than is described. For example, one or more of modules 108, 110, 112, 114, 116, 118, 120, 122, 124, 126, 128, 130, 132, 134, 136, 138, 140, 142, 144, 146, 148, 150, and/or 152 may be eliminated, and some or all of its functionality may be provided by other ones of modules 108, 110, 112, 114, 116, 118, 120, 122, 124, 126, 128, 130, 132, 134, 136, 138, 140, 142, 144, 146, 148, 150, and/or 152. As another example, processor(s) 158 may be configured to execute one or more additional modules that may perform some or all of the functionality attributed below to one of modules 108, 110, 112, 114, 116, 118, 120, 122, 124, 126, 128, 130, 132, 134, 136, 138, 140, 142, 144, 146, 148, 150, and/or 152.

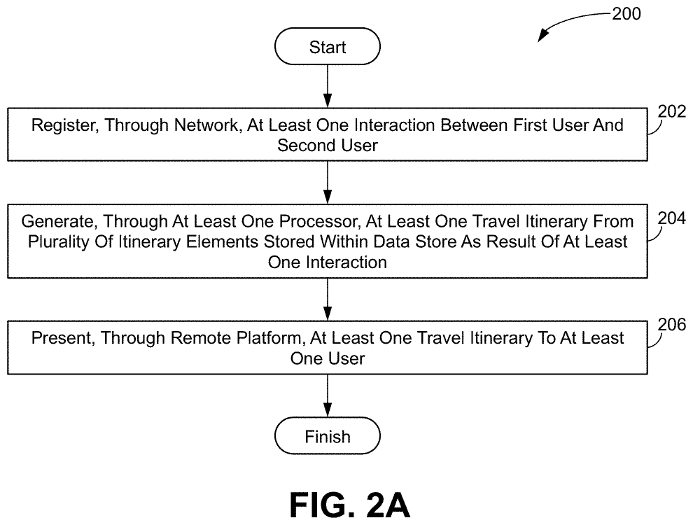

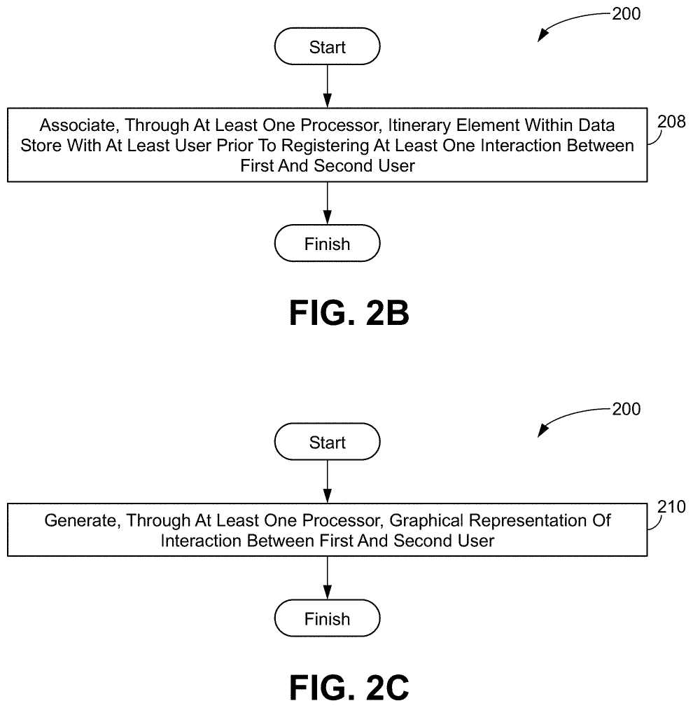

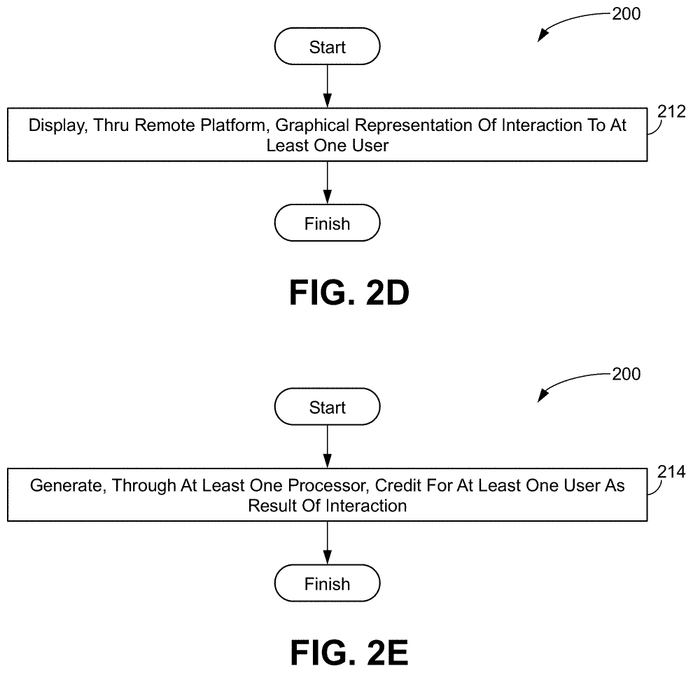

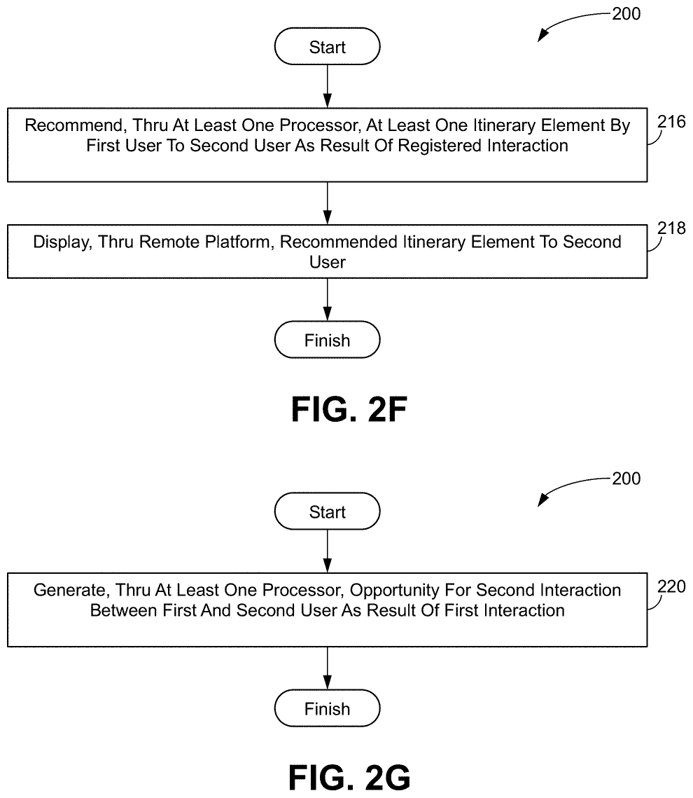

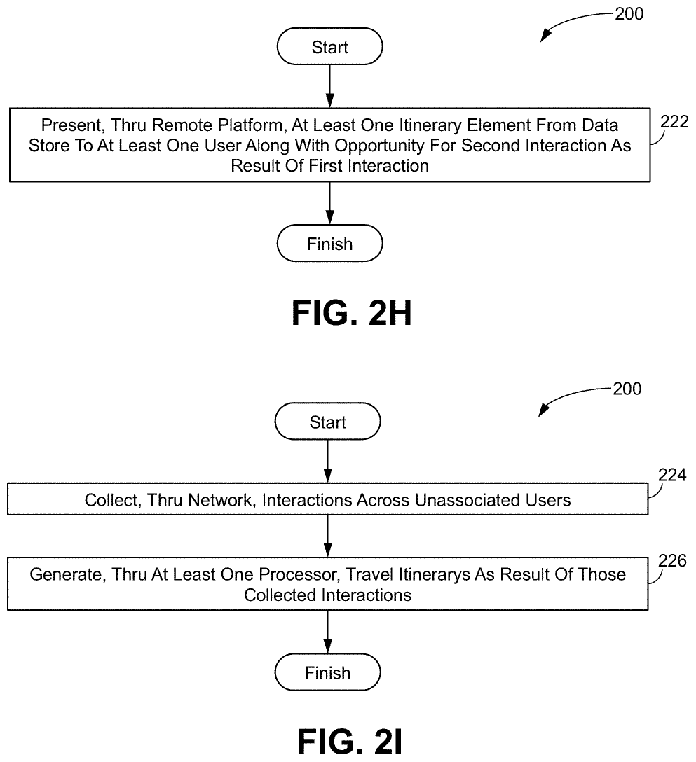

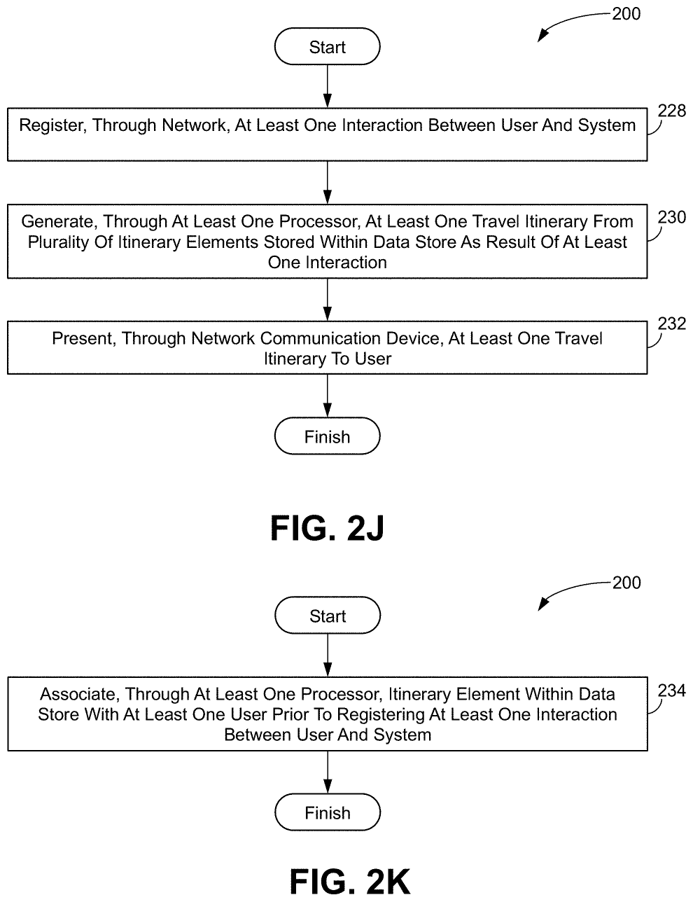

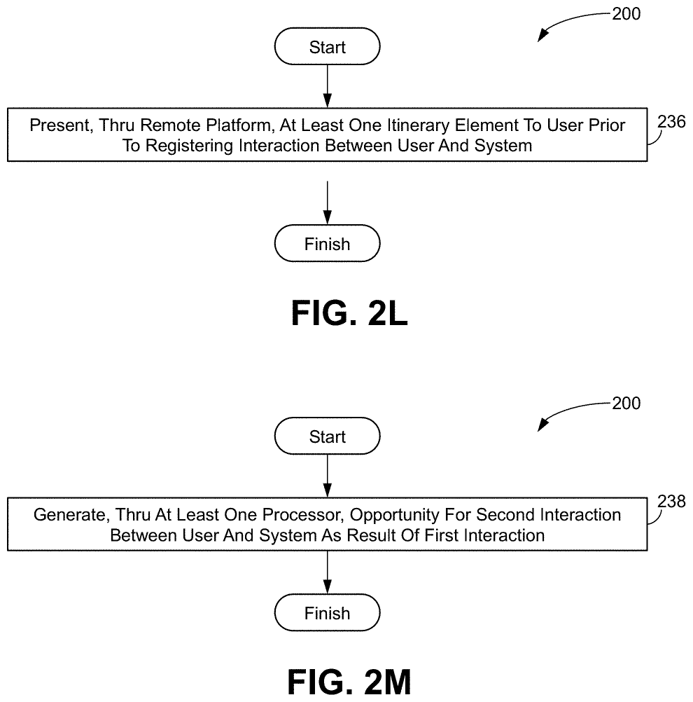

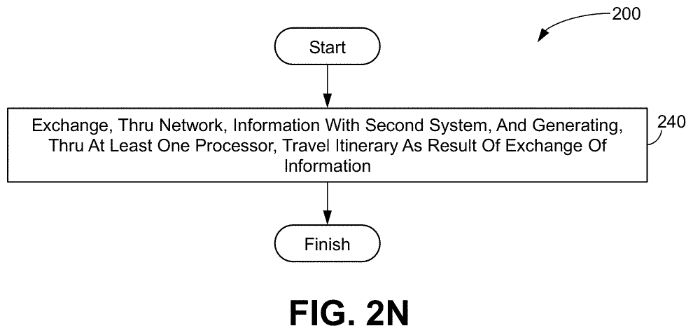

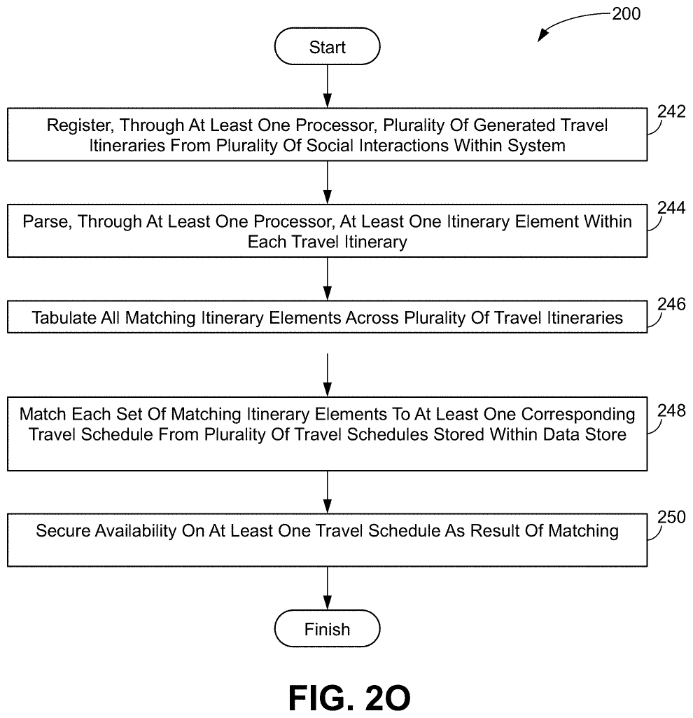

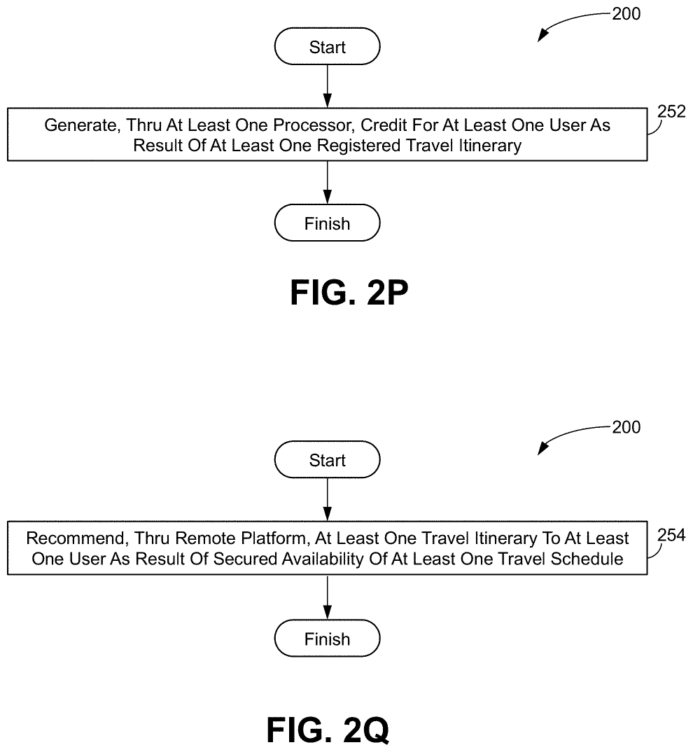

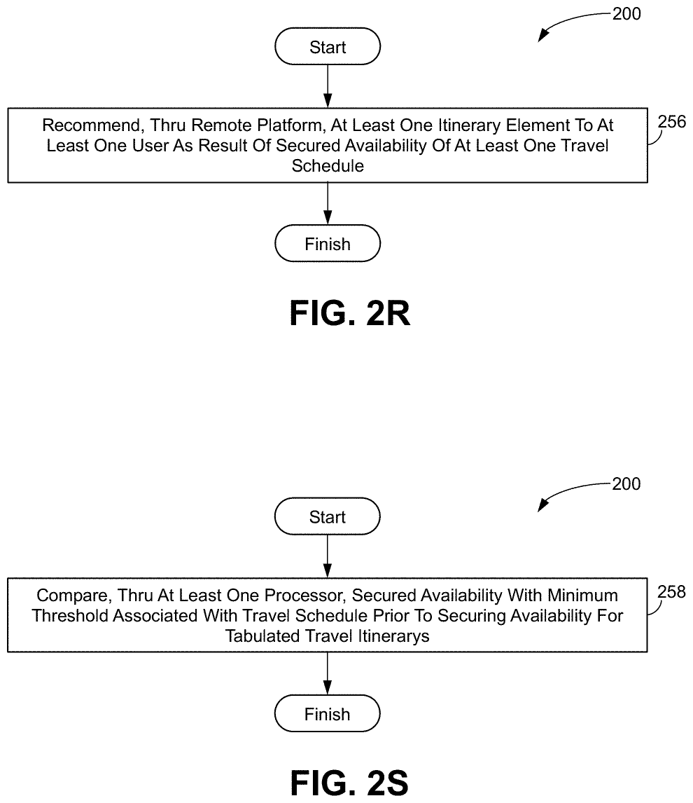

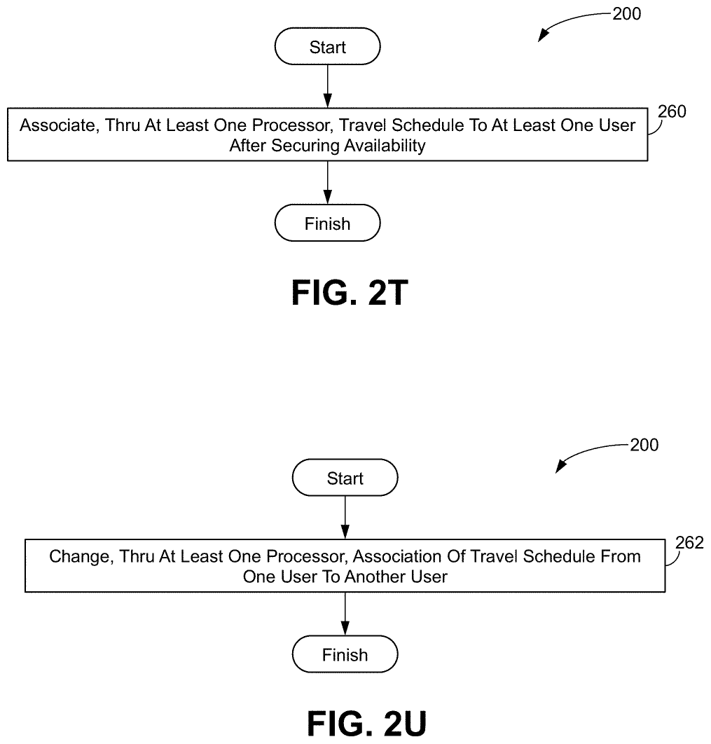

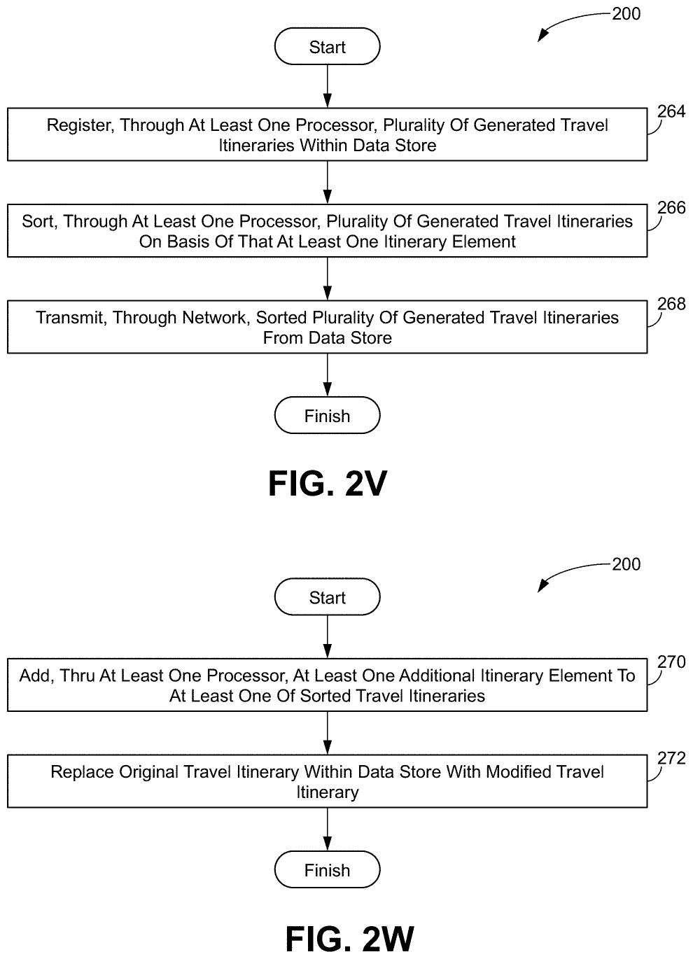

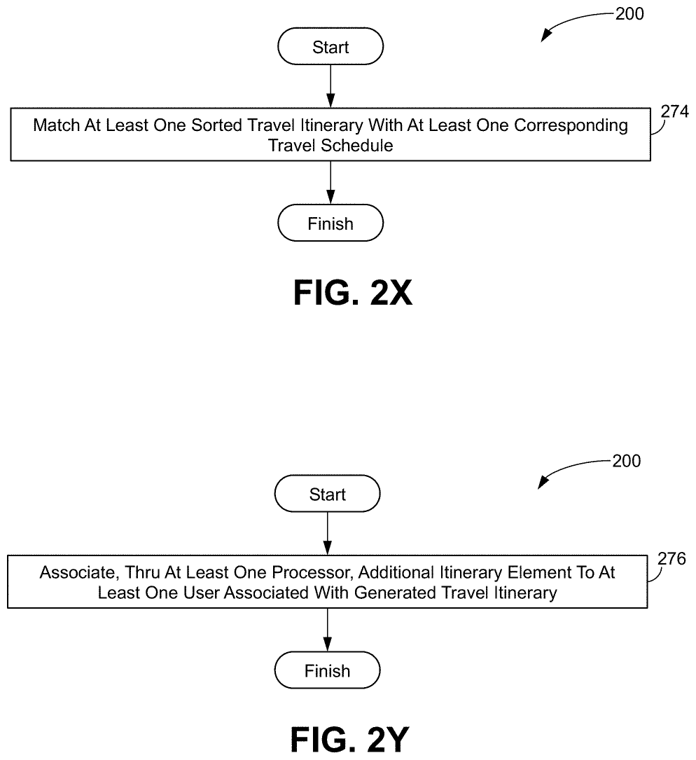

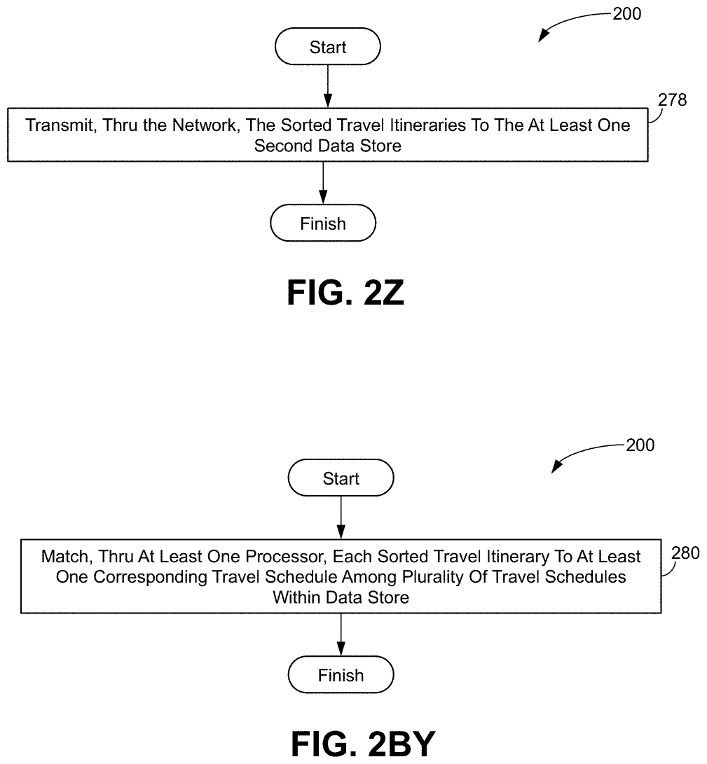

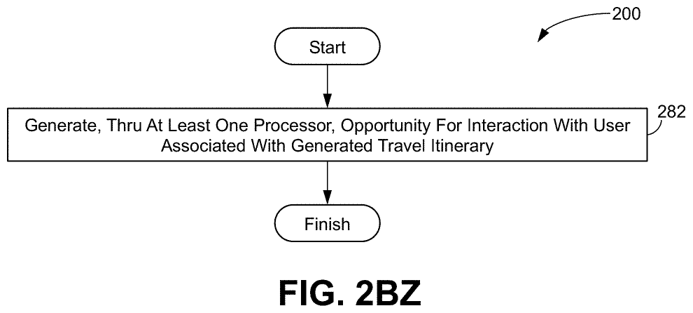

FIGS. 2A, 2B, 2C, 2D, 2E, 2F, 2G, 2H, 2I, 2J, 2K, 2L, 2M, 2N, 20, 2P, 2Q, 2R, 2S, 2T, 2U, 2V, 2W, 2X, 2Y, 2Z, 2BY, and/or 2BZ illustrates a method 200 for generating travel itineraries through a social interaction platform, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIGS. 2A, 2B, 2C, 2D, 2E, 2F, 2G, 2H, 2I, 2J, 2K, 2L, 2M, 2N, 20, 2P, 2Q, 2R, 2S, 2T, 2U, 2V, 2W, 2X, 2Y, 2Z, 2BY, and/or 2BZ and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

FIG. 2A illustrates method 200, in accordance with one or more implementations.

An operation 202 may include registering, through the network, at least one interaction between a first user and a second user. Operation 202 may be performed by one or more hardware processors configured by machine-readable instructions including a module that is the same as or similar to network registering module 108, in accordance with one or more implementations.

An operation 204 may include generating, through the at least one processor, at least one travel itinerary from a plurality of itinerary elements stored within the data store 160 as a result of the at least one interaction. Operation 204 may be performed by one or more hardware processors configured by machine-readable instructions including a module that is the same as or similar to processor travel itinerary generating module 110, in accordance with one or more implementations.

An operation 206 may include presenting, through the remote platform 104, the at least one travel itinerary to at least one user. Operation 206 may be performed by one or more hardware processors configured by machine-readable instructions including a module that is the same as or similar to remote platform presentment module 112, in accordance with one or more implementations.

FIG. 2B illustrates method 200, in accordance with one or more implementations.

An operation 208 may include associating, through the at least one processor, an itinerary element within the data store 160 with at least user prior to registering the at least one interaction between the first and second user. Operation 208 may be performed by one or more hardware processors configured by machine-readable instructions including a module that is the same as or similar to processor associating module 114, in accordance with one or more implementations.

FIG. 2C illustrates method 200, in accordance with one or more implementations.

An operation 210 may include generating, through the at least one processor, a graphical representation of the interaction between the first and second user. Operation 210 may be performed by one or more hardware processors configured by machine-readable instructions including a module that is the same as or similar to processor generating module 116, in accordance with one or more implementations.

FIG. 2D illustrates method 200, in accordance with one or more implementations.

An operation 212 may include displaying, thru the remote platform 104, the graphical representation of the interaction to at least one user. Operation 212 may be performed by one or more hardware processors configured by machine-readable instructions including a module that is the same as or similar to remote platform display module 118, in accordance with one or more implementations.

FIG. 2E illustrates method 200, in accordance with one or more implementations.

An operation 214 may include generating, through the at least one processor, a credit for at least one user as a result of the interaction. Operation 214 may be performed by one or more hardware processors configured by machine-readable instructions including a module that is the same as or similar to processor generating module 116, in accordance with one or more implementations.

FIG. 2F illustrates method 200, in accordance with one or more implementations.

An operation 216 may include recommending, thru the at least one processor, at least one itinerary element by the first user to the second user as a result of the registered interaction. Operation 216 may be performed by one or more hardware processors configured by machine-readable instructions including a module that is the same as or similar to processor recommending module 120, in accordance with one or more implementations.

An operation 218 may include displaying, thru the remote platform 104, the recommended itinerary element to the second user. Operation 218 may be performed by one or more hardware processors configured by machine-readable instructions including a module that is the same as or similar to remote platform display module 118, in accordance with one or more implementations.

FIG. 2G illustrates method 200, in accordance with one or more implementations.

An operation 220 may include generating, thru the at least one processor, an opportunity for a second interaction between the first and second user as a result of the first interaction. Operation 220 may be performed by one or more hardware processors configured by machine-readable instructions including a module that is the same as or similar to processor generating module 116, in accordance with one or more implementations.

FIG. 2H illustrates method 200, in accordance with one or more implementations.

An operation 222 may include presenting, thru the remote platform 104, at least one itinerary element from the data store 160 to at least one user along with the opportunity for a second interaction as a result of the first interaction. Operation 222 may be performed by one or more hardware processors configured by machine-readable instructions including a module that is the same as or similar to remote platform presentment module 112, in accordance with one or more implementations.

FIG. 2I illustrates method 200, in accordance with one or more implementations.

An operation 224 may include collecting, thru the network, interactions across unassociated users. Operation 224 may be performed by one or more hardware processors configured by machine-readable instructions including a module that is the same as or similar to network collection module 122, in accordance with one or more implementations.

An operation 226 may include generating, thru the at least one processor, travel itineraries as a result of those collected interactions. Operation 226 may be performed by one or more hardware processors configured by machine-readable instructions including a module that is the same as or similar to processor generating module 116, in accordance with one or more implementations.

FIG. 2J illustrates method 200, in accordance with one or more implementations.

An operation 228 may include registering, through the network, at least one interaction between a user and the system 100. Operation 228 may be performed by one or more hardware processors configured by machine-readable instructions including a module that is the same as or similar to network registering module 108, in accordance with one or more implementations.

An operation 230 may include generating, through the at least one processor, at least one travel itinerary from a plurality of itinerary elements stored within the data store 160 as a result of the at least one interaction. Operation 230 may be performed by one or more hardware processors configured by machine-readable instructions including a module that is the same as or similar to processor travel itinerary generating module 110, in accordance with one or more implementations.

An operation 232 may include presenting, through the remote platform 104, the at least one travel itinerary to the user. Operation 232 may be performed by one or more hardware processors configured by machine-readable instructions including a module that is the same as or similar to remote platform presentment module 112, in accordance with one or more implementations.

FIG. 2K illustrates method 200, in accordance with one or more implementations.

An operation 234 may include associating, through the at least one processor, an itinerary element within the data store 160 with at least one user prior to registering the at least one interaction between the user and the system 100. Operation 234 may be performed by one or more hardware processors configured by machine-readable instructions including a module that is the same as or similar to processor associating module 114, in accordance with one or more implementations.

FIG. 2L illustrates method 200, in accordance with one or more implementations.

An operation 236 may include presenting, thru the remote platform 104, at least one itinerary element to the user prior to registering the interaction between the user and the system 100. Operation 236 may be performed by one or more hardware processors configured by machine-readable instructions including a module that is the same as or similar to remote platform presentment module 112, in accordance with one or more implementations.

FIG. 2M illustrates method 200, in accordance with one or more implementations.

An operation 238 may include generating, thru the at least one processor, an opportunity for a second interaction between the user and the system 100 as a result of the first interaction. Operation 238 may be performed by one or more hardware processors configured by machine-readable instructions including a module that is the same as or similar to processor generating module 116, in accordance with one or more implementations.

FIG. 2N illustrates method 200, in accordance with one or more implementations.

An operation 240 may include exchanging, thru the network, information with a second system 100, and generating, thru the at least one processor, a travel itinerary as a result of the exchange of information. Operation 240 may be performed by one or more hardware processors configured by machine-readable instructions including a module that is the same as or similar to network exchange module 124, in accordance with one or more implementations.

FIG. 2O illustrates method 200, in accordance with one or more implementations.

An operation 242 may include registering, through the at least one processor, a plurality of generated travel itineraries from a plurality of social interactions within the system 100. Each travel itinerary may include at least one itinerary element. Operation 242 may be performed by one or more hardware processors configured by machine-readable instructions including a module that is the same as or similar to processor registering module 126, in accordance with one or more implementations.

An operation 244 may include parsing, through the at least one processor, at least one itinerary element within each travel itinerary. Operation 244 may be performed by one or more hardware processors configured by machine-readable instructions including a module that is the same as or similar to processor itinerary element parsing module 128, in accordance with one or more implementations.

An operation 246 may include tabulating all matching itinerary elements across the plurality of travel itineraries. Operation 246 may be performed by one or more hardware processors configured by machine-readable instructions including a module that is the same as or similar to itinerary element tabulation module 130, in accordance with one or more implementations.

An operation 248 may include matching each set of matching itinerary elements to at least one corresponding travel schedule from a plurality of travel schedules stored within the data store 160. Operation 248 may be performed by one or more hardware processors configured by machine-readable instructions including a module that is the same as or similar to set match module 132, in accordance with one or more implementations.

An operation 250 may include securing availability on the at least one travel schedule as a result of the matching. Operation 250 may be performed by one or more hardware processors configured by machine-readable instructions including a module that is the same as or similar to availability securing module 134, in accordance with one or more implementations.

FIG. 2P illustrates method 200, in accordance with one or more implementations.

An operation 252 may include generating, thru the at least one processor, a credit for at least one user as a result of at least one registered travel itinerary. Operation 252 may be performed by one or more hardware processors configured by machine-readable instructions including a module that is the same as or similar to processor generating module 116, in accordance with one or more implementations.

FIG. 2Q illustrates method 200, in accordance with one or more implementations.

An operation 254 may include recommending, thru the remote platform 104, at least one travel itinerary to at least one user as a result of secured availability of the at least one travel schedule. Operation 254 may be performed by one or more hardware processors configured by machine-readable instructions including a module that is the same as or similar to remote platform recommending module 136, in accordance with one or more implementations.

FIG. 2R illustrates method 200, in accordance with one or more implementations.

An operation 256 may include recommending, thru the remote platform 104, at least one itinerary element to at least one user as a result of secured availability of the at least one travel schedule. Operation 256 may be performed by one or more hardware processors configured by machine-readable instructions including a module that is the same as or similar to remote platform recommending module 136, in accordance with one or more implementations.

FIG. 2S illustrates method 200, in accordance with one or more implementations.

An operation 258 may include comparing, thru the at least one processor, the secured availability with a minimum threshold associated with the travel schedule prior to securing availability for the tabulated travel itineraries. Operation 258 may be performed by one or more hardware processors configured by machine-readable instructions including a module that is the same as or similar to processor comparing module 138, in accordance with one or more implementations.

FIG. 2T illustrates method 200, in accordance with one or more implementations.

An operation 260 may include associating, thru the at least one processor, a travel schedule to at least one user after securing availability. Operation 260 may be performed by one or more hardware processors configured by machine-readable instructions including a module that is the same as or similar to processor associating module 114, in accordance with one or more implementations.

FIG. 2U illustrates method 200, in accordance with one or more implementations.

An operation 262 may include changing, thru the at least one processor, the association of the travel schedule from one user to another user. Operation 262 may be performed by one or more hardware processors configured by machine-readable instructions including a module that is the same as or similar to processor changing module 140, in accordance with one or more implementations.

FIG. 2V illustrates method 200, in accordance with one or more implementations.

An operation 264 may include registering, through the at least one processor, a plurality of generated travel itineraries within the data store 160. Each travel itinerary may include at least one itinerary element. Operation 264 may be performed by one or more hardware processors configured by machine-readable instructions including a module that is the same as or similar to processor registering module 126, in accordance with one or more implementations.

An operation 266 may include sorting, through the at least one processor, the plurality of generated travel itineraries on the basis of that at least one itinerary element. Operation 266 may be performed by one or more hardware processors configured by machine-readable instructions including a module that is the same as or similar to processor sorting module 142, in accordance with one or more implementations.

An operation 268 may include transmitting, through the network, the sorted plurality of generated travel itineraries from the data store 160. Operation 268 may be performed by one or more hardware processors configured by machine-readable instructions including a module that is the same as or similar to network transmittal module 144, in accordance with one or more implementations.

FIG. 2W illustrates method 200, in accordance with one or more implementations.

An operation 270 may include adding, thru the at least one processor, at least one additional itinerary element to at least one of the sorted travel itineraries. Operation 270 may be performed by one or more hardware processors configured by machine-readable instructions including a module that is the same as or similar to processor adding module 146, in accordance with one or more implementations.

An operation 272 may include replacing the original travel itinerary within the data store 160 with the modified travel itinerary. Operation 272 may be performed by one or more hardware processors configured by machine-readable instructions including a module that is the same as or similar to travel itinerary replacing module 148, in accordance with one or more implementations.

FIG. 2X illustrates method 200, in accordance with one or more implementations.

An operation 274 may include matching at least one sorted travel itinerary with at least one corresponding travel schedule. Operation 274 may be performed by one or more hardware processors configured by machine-readable instructions including a module that is the same as or similar to travel itinerary match module 150, in accordance with one or more implementations.

FIG. 2Y illustrates method 200, in accordance with one or more implementations.

An operation 276 may include associating, thru the at least one processor, the additional itinerary element to at least one user associated with the generated travel itinerary. Operation 276 may be performed by one or more hardware processors configured by machine-readable instructions including a module that is the same as or similar to processor associating module 114, in accordance with one or more implementations.

FIG. 2Z illustrates method 200, in accordance with one or more implementations.

An operation 278 may include transmitting, thru the network, the sorted travel itineraries to the at least one second data store. Operation 278 may be performed by one or more hardware processors configured by machine-readable instructions including a module that is the same as or similar to network transmittal module 144, in accordance with one or more implementations.

FIG. 2BY illustrates method 200, in accordance with one or more implementations.

An operation 280 may include matching, thru the at least one processor, each sorted travel itinerary to at least one corresponding travel schedule among a plurality of travel schedules within the data store 160. Operation 280 may be performed by one or more hardware processors configured by machine-readable instructions including a module that is the same as or similar to processor match module 152, in accordance with one or more implementations.

FIG. 2BZ illustrates method 200, in accordance with one or more implementations.

An operation 282 may include generating, thru the at least one processor, an opportunity for an interaction with the user associated with the generated travel itinerary. Operation 282 may be performed by one or more hardware processors configured by machine-readable instructions including a module that is the same as or similar to processor generating module 116, in accordance with one or more implementations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium or data store may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a read only memory (ROM), optically readable storage media (e.g., CD-ROM, DVD), magnetically readable storage media (e.g., magnetic tape, magnetic hard drive, floppy drive), electrical charge-based storage media or random access memory (e.g., EEPROM, RAM), solid-state storage media (e.g., flash drive, solid-state hard drive), other electronically readable storage media and/or any suitable combination of the foregoing. In the context of this disclosure, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, and/or any suitable combination of the foregoing.

Computer program code for carrying out operations for aspects of the present invention may be written in any combination of one or more programming languages, including: object oriented programming languages such as Java, Smalltalk, C++, conventional procedural programming languages such as the “C” programming language or similar programming languages, scripting language such as Perl and/or VBS, functional languages such as Lisp and/or ML, logic-oriented languages such as Prolog, and/or blockchain smart contract languages such as Solidity, Move, Tezos, fi, and/or Plutus. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a virtual private network (VPN), and/or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus or device provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instruction embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively or may include one or more stand-alone components. The hardware and software components of the computer system of the present disclosure may include and may be included within fixed and portable devices such as desktops, laptops, and/or servers. A module may be a component of a device, software, program, or system that implements some “functionality,” which can be embodied as software, hardware, firmware, and/or electronic circuitry.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for generating travel itineraries through a social interaction platform, the system comprising:
one or more hardware processors configured by machine-readable instructions to:
register at least one interaction between a first user and a second user;
generate at least one travel itinerary from a plurality of itinerary elements stored within a data store as a result of the at least one interaction; and
present the at least one travel itinerary to at least one user.

2. The system of claim 1, wherein the one or more hardware processors are further configured by machine-readable instructions to:
associate an itinerary element within the data store with at least user prior to registering the at least one interaction between the first and second user.

3. The system of claim 1, wherein the at least one interaction includes the first and second user associating with the same itinerary element within the data store.

4. The system of claim 1, wherein the at least one interaction includes synchronous communication between the first and second user.

5. The system of claim 1, wherein the at least one interaction includes asynchronous communication between the first and second user.

6. The system of claim 1, wherein the at least one interaction includes a digital media file.

7. The system of claim 1, wherein the at least one interaction includes connecting the first and second user through the network.

8. The system of claim 1, wherein the one or more hardware processors are further configured by machine-readable instructions to:
generate a graphical representation of the interaction between the first and second user.

9. The system of claim 8, wherein the one or more hardware processors are further configured by machine-readable instructions to:
display the graphical representation of the interaction to at least one user.

10. The system of claim 8, wherein the graphical representation is generated as a heat map representing the interaction between the first and second user.

11. A method of generating travel itineraries through a social interaction platform, the method comprising:
registering at least one interaction between a first user and a second user;
generating, through the at least one processor, at least one travel itinerary from a plurality of itinerary elements stored within a data store as a result of the at least one interaction; and
presenting the at least one travel itinerary to at least one user.

12. The method of claim 11, further comprising:
associating an itinerary element within the data store with at least user prior to registering the at least one interaction between the first and second user.

13. The method of claim 11, wherein the at least one interaction includes the first and second user associating with the same itinerary element within the data store.

14. The method of claim 11, wherein the at least one interaction includes synchronous communication between the first and second user.

15. The method of claim 11, wherein the at least one interaction includes asynchronous communication between the first and second user.

16. The method of claim 11, wherein the at least one interaction includes a digital media file.

17. The method of claim 11, wherein the at least one interaction includes connecting the first and second user through the network.

18. The method of claim 11, further comprising:
generating a graphical representation of the interaction between the first and second user.

19. The method of claim 18, further comprising:
displaying the graphical representation of the interaction to at least one user.

20. A non-transient computer-readable storage medium having instructions embodied thereon, the instructions being executable by one or more processors to perform a method for generating travel itineraries through a social interaction platform, the method comprising:
registering at least one interaction between a first user and a second user;
generating, through the at least one processor, at least one travel itinerary from a plurality of itinerary elements stored within a data store as a result of the at least one interaction; and
presenting the at least one travel itinerary to at least one user.
